(19) United States
(12) Patent Application Publication
(10) Pub. No.: US 2011/0309017 A1
(43) Pub. Date: Dec. 22, 2011

(54) METHODS AND DEVICES FOR ENHANCING CONTAMINANT REMOVAL BY RARE EARTHS

(75) Inventors: Carl R. Hassler, Gig Harbor, WA (US); John L. Burba, III, Parker, CO (US); Charles F. Whitehead, Henderson, NV (US); Joseph Lupo, Henderson, NV (US); Timothy L. Oriard, Issaquah, WA (US)

(73) Assignee: MOLYCORP MINERALS, LLC, Greenwood Village, CO (US)

(21) Appl. No.: 13/086,247

(22) Filed: Apr. 13, 2011

Related U.S. Application Data
(60) Provisional application No. 61/323,758, filed on Apr. 13, 2010.
(60) Provisional application No. 61/325,996, filed on Apr. 20, 2010.

(51) Int. Cl. C02F 1/00; C02F 1/76; C02F 1/44; C02F 1/72; C02F 1/70; C02F 1/52; C02F 1/42; C02F 1/26; C02F 1/68; C02F 101/30; C02F 101/20; C02F 101/22; C02F 101/12; C02F 101/14; C02F 101/10; C02F 101/38; C02F 101/16; C02F 101/36; C02F 101/34

(52) U.S. Cl. 210/638; 210/749; 210/753; 210/758; 210/757; 210/723; 210/668; 210/759; 210/201; 210/764; 210/754

(57) ABSTRACT

Embodiments are provided for removing a variety of contaminants using both rare earth and non-rare earth-containing treatment elements.

### CROSS REFERENCE TO RELATED APPLICATION

The present application is claims the benefits of U.S. Provisional Patent Application Ser. Nos. 61/323,758, filed Apr. 13, 2010, and 61/325,996, filed Apr. 20, 2010, all of the same title and all of which are incorporated herein by this reference in their entirety.

### FIELD

The present disclosure relates generally to treatment of target material-containing fluids and particularly to rare earth treatment of target material-containing fluids.

### BACKGROUND

Rare earths and rare earth-containing compositions are a known way to remove selectively a variety of organic and inorganic contaminants from liquids. Rare earths are, however, relatively limited in availability and increasingly expensive. Additionally, rare earths can react preferentially with certain compounds or interferers, thereby preventing them from reacting with target materials of interest. Certain target materials of interest are optimally removed only by rare earths and not by other less expensive sorbents.

There is a need in water purification for greater selectivity in and control of the target materials exposed to a rare earth-containing contaminant removal agent.

### SUMMARY

These and other needs are addressed by the various aspects, embodiments, and configurations of the present disclosure. The disclosure is directed to the removal of various target materials by combinations of rare earths and/or rare earth compositions with other devices, materials, and processes (hereinafter “elements”).

In an aspect, an interferer is removed by a non-rare earth-containing treatment element upstream of a rare earth-containing treatment element or vice versa.

In an embodiment, a method and system are provided that includes the following steps/operations:

(a) receiving, by an input, a feed stream comprising a target material and an interferer, the target material and interferer being different;

(b) contacting the feed stream with an upstream treatment element to remove most or all of the interferer while leaving most or all of the target material in an intermediate feed stream; and

(c) thereafter contacting the feed stream with a downstream treatment element to remove most or all of the target material, wherein the interferer interferes with removal of the target material by the downstream treatment element, the upstream treatment element is one of a rare earth-containing treatment element and a non-rare earth-containing treatment element, and wherein the downstream treatment element is the other of a rare earth-containing treatment element and a non-rare earth-containing treatment element.

In one configuration, the downstream treatment element is the rare earth-containing treatment element, the upstream treatment element is the non-rare earth-containing treatment element, the interferer comprises one or more of the following: PO₄³⁻, CO₃²⁻, SiO₃²⁻, bicarbonate, vanadate, and a halogen, and the target material is one or more of a chemical agent, a colorant, a dye intermediate, a biological material, an organic carbon, a microbe, an oxyanion, and mixtures thereof.

In one configuration, the downstream treatment element is the non-rare earth-containing treatment element, the upstream treatment element is the rare earth-containing treatment element, and the interferer and target material are each one or more of a chemical agent, a colorant, a dye intermediate, a biological material, an organic carbon, a microbe, an oxyanion, a halogen, a halide compound, and mixtures thereof.

There are a number of examples of applications for this configuration.

In one example, the non-rare earth-containing treatment element is a membrane, and the interferer is one or more of a halogen and a halide compound.

In another example, the non-rare earth-containing treatment element comprises an oxidant, and the interferer is an oxidizable material. The oxidant, relative to the target material, preferentially oxidizes the interferer.

In another example, the non-rare earth-containing treatment element comprises a reductant, and the interferer is a reducible material. The reductant, relative to the target material, preferentially reduces the interferer.

In another example, the non-rare earth-containing treatment element comprises a precipitant, and the interferer is co-precipitated with the target material by the precipitant.

In another example, the non-rare earth-containing treatment element comprises an ion exchange medium, and the interferer is, relative to the target material, a competing ion for sites on the ion exchange medium.

In another example, the non-rare earth-containing treatment element comprises an ion exchange medium, and the interferer is a foulant, the at least one of a foulant detrimentally impacting operation of the non-rare earth-containing treatment element.

In another example, the non-rare earth-containing treatment element comprises an organic solvent in a solvent exchange circuit, and the interferer and the target material are, under the selected operating conditions of the solvent exchange circuit, soluble in the organic solvent.

In yet another example, the non-rare earth-containing treatment element comprises a copper/silver ionization treatment element, and the interferer comprises an oxyanion.

In a further example, the non-rare earth-containing treatment element is a peroxide process, and the interferer reacts with peroxide to substantially generate molecular oxygen.

In yet another example, the interferer is one or more of a phosphorus-containing composition, a carbon- and oxygen-containing compound, a halogen, a halogen-containing composition, and a silicon-containing composition.

Other examples will be appreciated by one of ordinary skill in the art based on the present disclosure.

In a further embodiment, a method and/or system includes the following steps/operations:

(a) receiving a feed stream comprising a target material, the target material being at a first pH and first temperature;

(b) contacting the feed stream with a non-rare earth-containing treatment element to remove at least a first portion of the target material to form an intermediate feed stream having a lower target material concentration than the feed stream;

(b) contacting the intermediate feed stream with a rare earth-containing treatment element to remove at least a second portion of the target material to form a treated feed stream, wherein, in a first mode, the non-rare earth-containing treatment element removes at least most of the target material when the first pH and/or first temperature is within a first set of values and, in a second mode, the non-rare earth-containing treatment element does not remove at least most of the target material when the first pH and/or first temperature is within a second set of values, the first and second set of values being nonoverlapping.

In one application, in the first mode, the rare earth-containing treatment element does not remove at least most of the target material, and, in the second mode, the rare earth-containing treatment element removes at least most of the target material.

In a further aspect, a method and system include the following steps/operations:

(a) receiving a feed stream comprising first and second target materials, the first and second target materials being one or more of a biological material and a microbe;

(b) treating, by a chlorine dioxide process, the feed stream to remove most or all of the first target material and form an intermediate stream; and

(c) treating, by a rare earth-containing treatment element, the intermediate stream to remove most or all of the second target material, the first and second target materials being different and the second target material being one or both of Escherichia coli and a rotovirus.

In a further aspect, a method and system include the following steps/operations:

(a) receiving a feed stream comprising one or more of a carbonate and bicarbonate;

(b) contacting the feed stream with a cerium(IV) compound to remove at least a portion (and commonly most or all) of the carbonate and/or bicarbonate and form a treated stream.

In a further aspect, a method and system include the following steps/operations:

(a) receiving a feed stream comprising a target material;

(b) contacting the feed stream with a rare earth-containing treatment element to remove at least a first portion of the target material to form an intermediate feed stream having a lower target material concentration than the feed stream; and

(b) contacting the intermediate feed stream with a non-rare earth-containing treatment element to remove at least a second portion of the target material to form a treated feed stream.

The target material can be a microbe, and the non-rare earth-containing treatment element comprises an anti-microbial agent, such as a halogenated resin.

These aspects can, as in the case of the former aspects, prolong the useful life of a more expensive non-rare earth-containing material or rare earth-containing material and thereby provide significant savings in operating costs. They can also provide duplication to avoid temporary loss of target material efficiency due to system upsets and variations or otherwise provide polishing filtration or removal of target materials.

These and other advantages will be apparent from the disclosure contained herein.

The term “a” or “an” entity refers to one or more of that entity. As such, the terms “a” (or “an”), “one or more” and “at least one” can be used interchangeably. It is also to be noted that the terms “comprising”, “including”, and “having” can be used interchangeably.

“Absorption” refers to the penetration of one substance into the inner structure of another, as distinguished from adsorption.

“Activated carbon” refers to highly porous carbon having a random or amorphous structure.

“Adsorption” refers to the adherence of atoms, ions, molecules, polyatomic ions, or other substances of a gas or liquid to the surface of another substance, called the adsorbent. The attractive force for adsorption can be, for example, ionic forces such as covalent or electrostatic forces, such as van der Waals and/or London's forces.

“Agglomerate” refers to the rare earth(s) and/or rare earth-containing composition nanoparticles and/or particles larger than nanoparticles formed into a cluster with another material, preferably a binder such as a polymeric binder.

“Aggregate” refers to separate units (such as but not limited to nanoparticles and/or particles larger than nanoparticles, or rare earth(s)) and/or rare earth-containing compositions gathered together to form a mass, the mass may be in the form of a mass of nanoparticles and/or particles larger than nanoparticles.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

A “binder,” refers to a material that promotes cohesion of aggregates or particles.

“Biological material” refers to one or both of organic and inorganic materials. The biological material may comprise a nutrient or a nutrient pathway component for one or more of the bacteria, algae, virus and/or fungi. The nutrient or the nutrient pathway component may be one of a phosphate, a carboxylic acid, a nitrogen compound (such as, ammonia, an amine, or an amide), an oxyanion, a nitrite, a toxin, or a combination thereof.

A “carbon-containing radical”, denoted by “R”, R′, R″, etc., refers to one or more of: a C₁ to C₂₅ straight-chain, branched aliphatic hydrocarbon radical; a C₅ to C₃₀ cycloaliphatic hydrocarbon radical; a C₆ to C₃₀ aromatic hydrocarbon radical; a C₇ to C₄₀ alkylaryl radical; a C₂ to C₂₅ linear or branched aliphatic hydrocarbon radical having interruption by one or more heteroatoms, such as, oxygen, nitrogen or sulfur; a C₂ to C₂₅ linear or branched aliphatic hydrocarbon radical having interruption by one or more functionalities selected from the group consisting essentially of a carbonyl (—C(O)—), an ester (—C(O)O—), an amide (—C(O)NH₀₋₂—), a C₂ to C₂₅ linear or branched aliphatic hydrocarbon radical functionalized with one or more of Cl, Br, F, I, NH_{(1 or 2)}, OH, and SH; a C₅ to C₃₀ cycloaliphatic hydrocarbon radical functionalized with one or more of Cl, Br, F, I, NH_{(1 or 2)}, OH, and SH; and a C₇ to C₄₀ alkylaryl radical radical functionalized with one or more of Cl, Br, F, I, NH_{(0, 1 or 2)}, OH, and SH.

A “chemical agent” includes known chemical warfare agents and industrial chemicals and materials, such as pesticides, rodenticides, herbicides, insecticides and fertilizers. In some embodiments, the chemical contaminant can include one or more of an organosulfur agent, an organophosphorous agent or a mixture thereof Specific non-limiting examples of such agents include o-alkyl phosphonofluoridates, such as sarin and soman, o-alkyl phosphoramidocyanidates, such as tabun, o-alkyl, s-2-dialkyl aminoethyl alkylphosphonothiolates and corresponding alkylated or protonated salts, such as VX, mustard compounds, including 2-chloroethylchloromethylsulfide, bis(2-chloroethyl)sulfide, bis(2-chloroethylthio)methane, 1,2-bis(2-chloroethylthio)ethane, 1,3-bis(2-chloroethylthio)-n-propane, 1,4-bis(2-chloroethylthio)-n-butane, 1,5-bis(2-chloroethylthio)-n-pentane, bis(2-chloroethylthiomethyl)ether, and bis(2-chloroethylthioethyl)ether, Lewisites, including 2-chlorovinyldichloroarsine, bis(2-chlorovinyl)chloroarsine, tris(2-chlorovinyl)arsine, bis(2-chloroethyl)ethylamine, and bis(2-chloroethyl)methylamine, saxitoxin, ricin, alkyl phosphonyldifluoride, alkyl phosphonites, chlorosarin, chlorosoman, amiton, 1,1,3,3,3,-pentafluoro-2-(trifluoromethyl)-1-propene, 3-quinuclidinyl benzilate, methylphosphonyl dichloride, dimethyl methylphosphonate, dialkyl phosphoramidic dihalides, alkyl phosphoramidates, diphenyl hydroxyacetic acid, quinuclidin-3-ol, dialkyl aminoethyl-2-chlorides, dialkyl aminoethane-2-ols, dialkyl aminoethane-2-thiols, thiodiglycols, pinacolyl alcohols, phosgene, cyanogen chloride, hydrogen cyanide, chloropicrin, phosphorous oxychloride, phosphorous trichloride, phosphorus pentachloride, alkyl phosphorous oxychloride, alkyl phosphites, phosphorous trichloride, phosphorus pentachloride, alkyl phosphites, sulfur monochloride, sulfur dichloride, and thionyl chloride.

A “colorant” is any substance that imparts color, such as a pigment or dye.

A “composition” refers to one or more chemical units composed of one or more atoms, such as a molecule, polyatomic ion, chemical compound, coordination complex, coordination compound, and the like. As will be appreciated, a composition can be held together by various types of bonds and/or forces, such as covalent bonds, metallic bonds, coordination bonds, ionic bonds, hydrogen bonds, electrostatic forces (e.g., van der Waal's forces and London's forces), and the like.

The term “deactivate” or “deactivation” includes rendering a target material, nontoxic, nonharmful, or nonpathogenic to humans and/or other animals, such as, for example, by killing the microorganism.

“De-toxify” or “de-toxification” includes rendering a chemical contaminant non-toxic to a living organism, such as, for example, a human and/or other animal. The chemical contaminant may be rendered non-toxic by converting the contaminant into a non-toxic form or species.

A “dye” is a colorant, usually transparent, which is soluble in an application medium. Dyes are classified according to chemical structure, usage, or application method. They are composed of groups of atoms responsible for the dye color, called chromophores, and intensity of the dye color, called auxchromes. The chemical structure classification of dyes, for example, uses terms such as azo dyes (e.g., monoazo, disazo, trisazo, polyazo, hydroxyazo, carboxyazo, carbocyclic azo, heterocyclic azo (e.g., indoles, pyrazolones, and pyridones), azophenol, aminoazo, and metalized (e.g., copper(II), chromium(III), and cobalt(III)) azo dyes, and mixtures thereof), anthraquinone (e.g., tetra-substituted, disubstituted, trisubstituted and momosubstitued, anthroaquinone dyes (e.g., quinolines), premetallized anthraquinone dyes (including polycyclic quinones), and mixtures thereof), benzodifuranone dyes, polycyclic aromatic carbonyl dyes, indigoid dyes, polymethine dyes (e.g., azacarobocyanine, diazacarbocyanine, cyanine, hemicyanine, and diazahemicyanine dyes, triazolium, benothiazolium, and mixtures thereof), styryl dyes, (e.g., dicyanovinyl, tricyanovinyl, tetracvanoctylene dyes) diaryl carbonium dyes, triaryl carbonium dyes, and heterocyclic derivates thereof (e.g., triphenylmethane, diphenylmethane, thiazine, triphendioxazine, pyronine (xanthene) derivatives and mixtures thereof), phthalocyanine dyes (including metal-containing phthalocyanine dyes), quinophthalone dyes, sulfur dyes, (e.g., phenothiazonethianthrone) nitro and nitroso dyes (e.g., nitrodiphenylamines, metal-complex derivatives of o-nitrosophenols, derivatives of naphthols, and mixtures thereof), stilbene dyes, formazan dyes, hydrazone dyes (e.g., isomeric 2-phenylazo-1-naphthols, 1-phenylazo-2-naphthols, azopyrazolones, azopyridones, and azoacetoacetanilides), azine dyes, xanthene dyes, triarylmethane dyes, azine dyes, acridine dyes, oxazine dyes, pyrazole dyes, pyrazalone dyes, pyrazoline dyes, pyrazalone dyes, coumarin dye, naphthalimide dyes, carotenoid dyes (e.g., aldehydic carotenoid, β-carotene, canthaxanthin, and β-Apo-8′-carotenal), flavonol dyes, flavone dyes, chroman dye, aniline black dye, indeterminate structures, basic dye, quinacridone dye, formazan dye, triphendioxazine dye, thiazine dye, ketone amine dyes, caramel dye, poly(hydroxyethyl methacrylate)-dye copolymers, riboflavin, and copolymers, derivatives, and mixtures thereof The application method classification of dyes uses the terms reactive dyes, direct dyes, mordant dyes, pigment dyes, anionic dyes, ingrain dyes, vat dyes, sulfur dyes, disperse dyes, basic dyes, cationic dyes, solvent dyes, and acid dyes.

A “dye intermediate” refers to a dye precursor or intermediate. A dye intermediate includes both primary intermediates and dye intermediates. Dye intermediates are generally divided into carbocycles, such as benzene, naphthalene, sulfonic acid, diazo-1, 2, 4-acid, anthraquinone, phenol, aminothiazole nitrate, aryldiazonium salts, arylalkylsulfones, toluene, anisole, aniline, anilide, and chrysazin, and heterocycles, such as pyrazolones, pyridines, indoles, triazoles, aminothiazoles, aminobenzothiazoles, benzoisothiazoles, triazines, and thiopenes.

A “fluid” refers to any material or substance that has the ability to one or more flow, take on the shape of a container holding the material or substance, and/or be substantially non-resistant to deformation (that is substantially continually deform under an applied shear stress). The term applies not only to liquids but also to gases and to finely divided solids. Fluids are broadly classified as Newtonian and non-Newtonian depending on their obedience to the laws of classical mechanics.

A “halogen” is a series of nonmetal elements from Group 17 IUPAC Style (formerly: VII, VIIA) of the periodic table, comprising fluorine (F), chlorine (Cl), bromine (Br), iodine (I), and astatine (At). The artificially created element 117, provisionally referred to by the systematic name ununseptium, may also be a halogen. A “halide compound” is a compound having as one part of the compound at least one halogen atom and the other part the compound is an element or radical that is less electronegative (or more electropositive) than the halogen. The halide compound is typically a fluoride, chloride, bromide, iodide, or astatide compound. Many salts are halides having a halide anion. A halide anion is a halogen atom bearing a negative charge. The halide anions are fluoride (F), chloride (CF), bromide (Br⁻), iodide (I⁻) and astatide (At⁻).

“Industrial chemicals and materials” include chemicals and/or materials having anionic functional groups, such as phosphates, sulfates and nitrates, and electro-negative functional groups, such as chlorides, fluorides, bromides, ethers and carbonyls. Specific non-limiting examples can include acetaldehyde, acetone, acrolein, acrylamide, acrylic acid, acrylonitrile, aldrin/dieldrin, ammonia, aniline, arsenic, atrazine, barium, benzidine, 2,3-benzofuran, beryllium, 1,1′-biphenyl, bis(2-chloroethyl)ether, bis(chloromethyl)ether, bromodichloromethane, bromoform, bromomethane, 1,3-butadiene, 1-butanol, 2-butanone, 2-butoxyethanol, butraldehyde, carbon disulfide, carbon tetrachloride, carbonyl sulfide, chlordane, chlorodecone and mirex, chlorfenvinphos, chlorinated dibenzo-p-dioxins (CDDs), chlorine, chlorobenzene, chlorodibenzofurans (CDFs), chloroethane, chloroform, chloromethane, chlorophenols, chlorpyrifos, cobalt, copper, creosote, cresols, cyanide, cyclohexane, DDT, DDE, DDD, DEHP, di(2-ethylhexyl)phthalate, diazinon, dibromochloropropane, 1,2-dibromoethane, 1,4-dichlorobenzene, 3,3′-dichlorobenzidine, 1,1-dichloroethane, 1,2-dichloroethane, 1,1-dichloroethene, 1,2-dichloroethene, 1,2-dichloropropane, 1,3-dichloropropene, dichlorvos, diethyl phthalate, diisopropyl methylphosphonate, di-n-butylphtalate, dimethoate, 1,3-dinitrobenzene, dinitrocresols, dinitrophenols, 2,4- and 2,6-dinitrotoluene, 1,2-diphenylhydrazine, di-n-octylphthalate (DNOP), 1,4-dioxane, dioxins, disulfoton, endosulfan, endrin, ethion, ethylbenzene, ethylene oxide, ethylene glycol, ethylparathion, fenthions, fluorides, formaldehyde, freon 113, heptachlor and heptachlor epoxide, hexachlorobenzene, hexachlorobutadiene, hexachlorocyclohexane, hexachlorocyclopentadiene, hexachloroethane, hexamethylene diisocyanate, hexane, 2-hexanone, HMX (octogen), hydraulic fluids, hydrazines, hydrogen sulfide, iodine, isophorone, malathion, MBOCA, methamidophos, methanol, methoxychlor, 2-methoxyethanol, methyl ethyl ketone, methyl isobutyl ketone, methyl mercaptan, methylparathion, methyl t-butyl ether, methylchloroform, methylene chloride, methylenedianiline, methyl methacrylate, methyl-tert-butyl ether, mirex and chlordecone, monocrotophos, N-nitrosodimethylamine, N-nitrosodiphenyl amine, N-nitrosodi-n-propylamine, naphthalene, nitrobenzene, nitrophenols, perchloroethylene, pentachlorophenol, phenol, phosphamidon, phosphorus, polybrominated biphenyls (PBBs), polychlorinated biphenyls (PCBs), polycyclic aromatic hydrocarbons (PAHs), propylene glycol, phthalic anhydride, pyrethrins and pyrethroids, pyridine, RDX (cyclonite), selenium, styrene, sulfur dioxide, sulfur trioxide, sulfuric acid, 1,1,2,2-tetrachloroethane, tetrachloroethylene, tetryl, thallium, tetrachloride, trichlorobenzene, 1,1,1-trichloroethane, 1,1,2-trichloroethane, trichloroethylene (TCE), 1,2,3-trichloropropane, 1,2,4-trimethylbenzene, 1,3,5-trinitrobenzene, 2,4,6-trinitrotoluene (TNT), vinyl acetate, and vinyl chloride.

An “inorganic material” refers to any material substantially devoid of a rare earth that is not an organic material. Examples of inorganic materials include silicates, carbonates, sulfates, and phosphates.

An “interferer” is any material that degrades, deteriorates, damages, or otherwise adversely impacts the performance of a treatment element, such as a rare earth or rare earth-containing composition, activated carbon, block carbon, and the like. For example, the interferer can be a material that is preferentially sorbed, precipitated, deactivated, killed, or otherwise neutralized by the rare earth-containing treatment element, thereby interfering with removal of a target material. Stated another way, the rare earth-containing treatment element is capable of removing, by sorbing, precipitating, deactivating, killing or otherwise neutralizing both the interferer and target material. When a stream containing an interfere and target material is contacted with a rare earth-containing treatment element, at least some of the rare earth and/or rare earth-containing composition is unavailable for target material removal due to one or more of the sorption, precipitation, deactivation, killing or otherwise neutralization of the interferer. Another example of an interferer is a material that decreases the operating life of the non rare earth-containing treatment element. The preference or removal capacity of the target material removal agent for the interferer may be slightly less than that of the target material but the concentration of the interferer in the feed stream to be treated is substantial, thereby decreasing the effective capacity of the target material removal agent for the target material.

“Ion exchange medium” refers to a medium that is able, under selected operating conditions, to exchange ions between two electrolytes or between an electrolyte solution and a complex. Examples of ion exchange resins include solid polymeric or mineralic “ion exchangers”. Other exemplary ion exchangers include ion exchange resins (functionalized porous or gel polymers), zeolites, montmorillonite clay, clay, and soil humus. Ion exchangers are commonly either cation exchangers that exchange positively charged ions (cations) or anion exchangers that exchange negatively charged ions (anions). There are also amphoteric exchangers that are able to exchange both cations and anions simultaneously. Ion exchangers can be unselective or have binding preferences for certain ions or classes of ions, depending on their chemical structure. This can be dependent on the size of the ions, their charge, or their structure. Typical examples of ions that can bind to ion exchangers are: H⁺ (proton) and OH⁻ (hydroxide); single-charged monoatomic ions like Na⁺, K⁺, and Cl⁻; double-charged monoatomic ions like Ca²⁺ and Mg²⁺; polyatomic inorganic ions like SO₄²⁻ and PO₄³⁻; organic bases, usually molecules containing the amino functional group —NR₂H⁺; organic acids often molecules containing —COO⁻ (carboxylic acid) functional groups; and biomolecules that can be ionized: amino acids, peptides, proteins, etc.

“Microbe”, “microorganism”, and “biological contaminant” refer to any microscopic organism, or microorganism, whether pathogenic or nonpathogenic to humans, including, without limitation, prokaryotic and eukaryotic-type organisms, such as the cellular forms of life, namely bacteria, archaea, and eucaryota and non-cellular forms of life, such as viruses. Common microbes include, without limitation, bacteria, fungi, protozoa, viruses, prion, parasite, and other biological entities and pathogenic species. Specific non-limiting examples of bacteria include Escherichia coli, Streptococcus faecalis, Shigella spp, Leptospira, Legimella pneumophila, Yersinia enterocolitica, Staphylococcus aureus, Pseudomonas aeruginosa, Klebsiella terrigena, Bacillus anthracis, Vibrio cholrae, Salmonella typhi, of viruses, include hepatitis A, noroviruses, rotaviruses, and enteroviruses, and of protozoa include Entamoeba histolytica, Giardia, Cryptosporidium parvum.

“Organic carbons” or “organic material” refer to any compound of carbon except such binary compounds as carbon oxides, the carbides, carbon disulfide, etc.; such ternary compounds as the metallic cyanides, metallic carbonyls, phosgene, carbonyl sulfide, etc.; and the metallic carbonates, such as alkali and alkaline earth metal carbonates. Exemplary organic carbons include humic acid, tannins, and tannic acid, polymeric materials, alcohols, carbonyls, carboxylic acids, oxalates, amino acids, hydrocarbons, and mixtures thereof. In some embodiments, the target material is an organic material as defined herein. An alcohol is any organic compound in which a hydroxyl functional group (—OH) is bound to a carbon atom, the carbon atom is usually connected to other carbon or hydrogen atoms. Examples of alcohols include acyclic alcohols, isopropyl alcohol, ethanol, methanol, pentanol, polyhydric alcohols, unsaturated aliphatic alcohols, and alicyclic alcohols, and the like. The carbonyl group is a functional group consisting of a carbonyl (RR′C═O) (in the form without limitation a ketone, aldehyde, carboxylic acid, ester, amide, acyl halide, acid ahydride or combinations thereof). Examples of organic compounds containing a carbonyl group include aldehydes, ketones, esters, amides, enones, acyl halides, acid anhydrides, urea, and carbamates and derivatives thereof, and the derivatives of acyl chlorides chloroformates and phosgene, carbonate esters, thioesters, lactones, lactams, hydroxamates, and isocyanates. Preferably, the carbonyl group comprises a carboxylic acid group, which has the formula —C(═O)OH, usually written as —COOH or —CO₂H. Examples of organic compounds containing a carboxyl group include carboxylic acid (R—COOH) and salts and esters (or carboxylates) and other derivatives thereof. It can be appreciated that organic compounds include alcohols, carbonyls, and carboxylic acids, where one or more oxygens are, respectively, replaced with sulfur, selenium and/or tellurium.

“Organophorous” refers to a chemical compound containing one or more carbon-phosphorous bonds. “Insoluble” refers to materials that are intended to be and/or remain as solids in water and are able to be retained in a device, such as a column, or be readily recovered from a batch reaction using physical means, such as filtration. Insoluble materials should be capable of prolonged exposure to water, over weeks or months, with little (<5%) loss of mass.

“Oxidizing agent”, “oxidant” or “oxidizer” refers to an element or compound that accepts one or more electrons to another species or agent this is oxidized. In the oxidizing process the oxidizing agent is reduced and the other species which accepts the one or more electrons is oxidized. More specifically, the oxidizer is an electron acceptor or recipient and the reductant is an electron donor or giver.

“Oxyanion” or oxoanion is a chemical compound with the generic formula AₓO_{y}^{z-} (where A represents a chemical element other than oxygen and O represents an oxygen atom). In target material-containing oxyanions, “A” represents metal, metalloid, and/or Se (which is a non-metal), atoms. Examples for metal-based oxyanions include chromate, tungstate, molybdate, aluminates, zirconate, etc. Examples of metalloid-based oxyanions include arsenate, arsenite, antimonate, germanate, silicate, etc. The oxyanions can be in the form of a complex anion of metal, metalloid, and nonmetal having an atomic number selected from the group of consisting of atomic numbers 5, 9, 13, 14, 22 to 25, 26, 27, 30, 31, 32, 33, 34, 35, 40 to 42, 44, 45, 48 to 53, 72 to 75, 77, 78, 80, 81, 82, 83, 85, 92, 94, 95, and 96 and even more preferably from the group consisting of atomic numbers 5, 13, 14, 22 to 25, 31, 32, 33, 34, 40 to 42, 44, 45, 49 to 52, 72 to 75, 76, 77, 78, 80, 81, 82, 83, 92, 94, 95, and 96. These atomic numbers include the elements of antimony, arsenic, aluminum, astatine, bromine, boron, fluorine, iodine, silicon, titanium, vanadium, chromium, manganese, gallium, thallium, germanium, selenium, mercury, zirconium, niobium, molybdenum, ruthenium, rhodium, indium, tin, antimony, tellurium, hafnium, tantalum, tungsten, rhenium, iridium, platinum, lead, uranium, plutonium, americium, curium, and bismuth. The target material can be mixtures or compounds of these elements. Uranium with an atomic number of 92 is an example of an oxyanion of a radioactive isotope.

A “particle” refers to a solid, colloid, or microencapsulated liquid with no limitation in shape or size.

A “pigment” is a synthetic or natural (biological or mineral) material that changes the color of reflected or transmitted light as the result of wavelength-selective absorption. This physical process differs from fluorescence, phosphorescence, and other forms of luminescence, in which a material emits light. The pigment may comprise inorganic and/or organic materials. Inorganic pigments include elements, their oxides, mixed oxides, sulfides, chromates, silicates, phosphates, and carbonates. Examples of inorganic pigments, include cadmium pigments, carbon pigments (e.g., carbon black), chromium pigments (e.g., chromium hydroxide green and chromium oxide green), cobalt pigments, copper pigments (e.g., chlorophyllin and potassium sodium copper chlorophyllin), pyrogallol, pyrophyllite, silver, iron oxide pigments, clay earth pigments, lead pigments (e.g., lead acetate), mercury pigments, titanium pigments (e.g., titanium dioxide), ultramarine pigments, aluminum pigments (e.g., alumina, aluminum oxide, and aluminum powder), bismuth pigments (e.g., bismuth vanadate, bismuth citrate and bismuth oxychloride), bronze powder, calcium carbonate, chromium-cobalt-aluminum oxide, cyanide iron pigments (e.g., ferric ammonium ferrocyanide, ferric and ferrocyanide), manganese violet, mica, zinc pigments (e.g., zinc oxide, zinc sulfide, and zinc sulfate), spinels, rutiles, zirconium pigments (e.g., zirconium oxide and zircon), tin pigments (e.g., cassiterite), cadmium pigments, lead chromate pigments, luminescent pigments, lithopone (which is a mixture of zinc sulfide and barium sulfate), metal effect pigments, nacreous pigments, transparent pigments, and mixtures thereof. Examples of synthetic organic pigments include ferric ammonium citrate, ferrous gluconate, dihydroxyacetone, guaiazulene, and mixtures thereof. Examples of organic pigments from biological sources include alizarin, alizarin crimson, gamboge, cochineal red, betacyanins, betataxanthins, anthocyanin, logwood extract, pearl essence, paprika, paprika oleoresins, saffron, turmeric, turmeric oleoresin, rose madder, indigo, Indian yellow, tagetes meal and extract, Tyrian purple, dried algae meal, henna, fruit juice, vegetable juice, toasted partially defatted cooked cottonseed flour, quinacridone, magenta, phthalo green, phthalo blue, copper phthalocyanine, indanthone, triarylcarbonium sulfonate, triarylcarbonium PTMA salt, triaryl carbonium Ba salt, triarylcarbonium chloride, polychloro copper phthalocyanine, polybromochlor copper phthalocyanine, monoazo, disazo pyrazolone, monoazo benzimid-azolone, perinone, naphthol AS, beta-naphthol red, naphthol AS, disazo pyrazolone, BONA, beta naphthol, triarylcarbonium PTMA salt, disazo condensation, anthraquinone, perylene, diketopyrrolopyrrole, dioxazine, diarylide, isoindolinone, quinophthalone, isoindoline, monoazo benzimidazolone, monoazo pyrazolone, disazo, benzimidazolones, diarylide yellow dintraniline orange, pyrazolone orange, para red, lithol, azo condensation, lake, diaryl pyrrolopyrrole, thioindigo, aminoanthraquinone, dioxazine, isoindolinone, isoindoline, and quinphthalone pigments, and mixtures thereof. Pigments can contain only one compound, such as single metal oxides, or multiple compounds. Inclusion pigments, encapsulated pigments, and lithopones are examples of multi-compound pigments. Typically, a pigment is a solid insoluble powder or particle having a mean particle size ranging from about 0.1 to about 0.3 μm, which is dispersed in a liquid. The liquid may comprise a liquid resin, a solvent or both. Pigment-containing compositions can include extenders and opacifiers.

“Precipitation” refers not only to the removal of target material-containing ions in the form of insoluble species but also to the immobilization of contaminant-containing ions or other components on or in insoluble particles. For example, “precipitation” includes processes, such as adsorption and/or absorption.

A “radiative treatment element” refers to a treatment element comprising electromagnetic energy to remove one or both of interferer and target material. The electromagnetic is selected from the group of microwave energy (typically having a wavelength of about 10⁻² m and/or a frequency from about 10⁹ to about 10¹¹ Hz), infrared energy (typically having a wavelength of about 10⁻⁵ m and/or a frequency from about 10¹¹ to about 10¹⁴ Hz), visible light energy (typically having a wavelength of about 0.5×10⁻⁶ m and/or a frequency from about 10¹⁴ to about 10¹⁵ Hz), ultraviolet energy (typically having a wavelength of about 10⁻⁸ m and/or a frequency from about 10¹⁵ to about 10¹⁷ Hz), x-ray energy (typically having a wavelength of about 10⁻¹⁰ m and/or a frequency from about 10¹⁷ to about 10¹⁹ Hz), and gamma ray energy (typically having a wavelength of about 10⁻¹⁹ m and/or a frequency from about 10¹⁹ to about 10²⁰ Hz).

A “rare earth” refers to one or more of yttrium, scandium, lanthanum, cerium, praseodymium, neodymium, samarium, europium, gadolinium, terbium, dysprosium, holmium erbium, thulium, ytterbium, and lutetium. As will be appreciated, lanthanum, cerium, praseodymium, neodymium, samarium, europium, gadolinium, terbium, dysprosium, holmium erbium, thulium, ytterbium, and lutetium are known as lanthanoids.

“Reducing agent”, “reductant” or “reducer” refers to an element or compound that donates one or more electrons to another species or agent this is reduced. In the reducing process, the reducing agent is oxidized and the other species, which accepts the one or more electrons, is oxidized. More specifically, the reducer is an electron donor and the oxidant is an electron acceptor or recipient.

The terms “remove” or “removing” include the sorption, precipitation, adsorption, absorption, conversion, deactivation, decomposition, degradation, neutralization, and/or killing of a target material.

“Soluble” refers to materials that readily dissolve in water. For purposes of this invention, it is anticipated that the dissolution of a soluble compound would necessarily occur on a time scale of minutes rather than days. For the compound to be considered to be soluble, it is necessary that it has a significantly high solubility product such that upwards of 5 g/L of the compound will be stable in solution.

“Solvent extraction” refers to a process in which a mixture of an extractant in a diluent is used to extract a metal from one phase to another. In solvent extraction, this mixture is often referred to as the “organic” because the main constituent (diluent) is commonly some type of oil. For example, in hydrometallurgy a pregnant leach solution is mixed to emulsification with a stripped organic and allowed to separate. A valuable metal, such as copper, is exchanged from the pregnant leach solution to the organic. The resulting streams will be a loaded organic and a raffinate. When dealing with electrowinning, the loaded organic is then mixed to emulsification with a lean electrolyte and allowed to separate. The metal will be exchanged from the organic to the electrolyte. The resulting streams will be a stripped organic and a rich electrolyte. The organic stream is recycled through the solvent extraction process while the aqueous streams cycle through leaching and electrowinning processes, respectively.

“Sorb” refers to adsorption and/or absorption.

“Treatment element” refers to any device, material, and/or process for removing one or both of an interferer and a target material.

The preceding is a simplified summary of the disclosure to provide an understanding of some aspects, embodiments, and configurations of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosed aspects, embodiments, and configurations can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram according to an embodiment;

FIG. 2 is a block diagram according to an embodiment;

FIG. 3 is a plot of percent humic acid retained on ceria-coated alumina as a function of the volume of humic acid-containing solution contacted with the ceria-coated alumina;

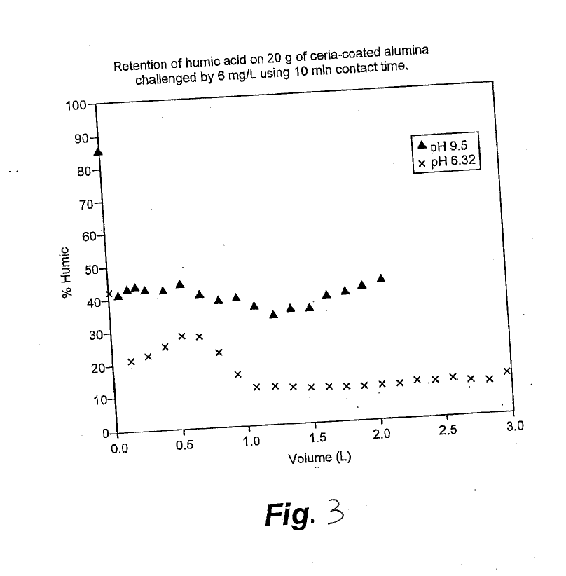

FIG. 4 is a plot of the residual arsenic concentration (mg/L) against molar ratio of cerium(III):arsenic;

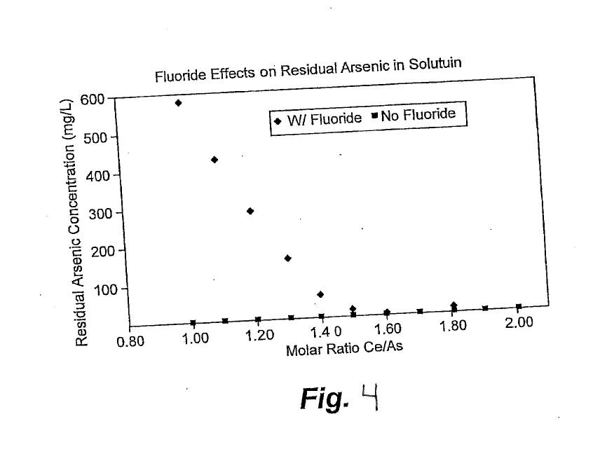

FIG. 5 is a plot of loading capacity (As mg/CeO₂ g) against molar ratio cerium(III):arsenic;

FIG. 6 is a plot of arsenic capacity (mg As/g CeO₂) against various solution compositions;

FIG. 7 is a plot of arsenic (V) concentration (ppb) against bed volumes treated; and

FIG. 8 is a plot of arsenic removal capacity (mg As/g CeO₂) against various solution compositions.

### DETAILED DESCRIPTION

### General Overview

A fluid containing an interferer and a target material is treated sequentially with a rare earth-containing treatment element and with a non-rare earth-containing treatment element. In some embodiments, the rare earth-containing treatment element is upstream of the non-rare earth-containing treatment element. In such an instance, the non-rare earth-containing treatment element is downstream of the rare earth-containing element.

In other embodiments, the non-rare earth-containing treatment element is upstream of the rare earth-containing element. In such an instance, the rare earth-containing element is downstream of the non-rare earth-containing treatment element.

Preferably, the upstream treatment element removes at least most, if not all, of the interferer. Furthermore, the downstream treatment element removes at least most, if not all, of the target material.

In some embodiments, the interferer is a material that one or more of impedes, competes with, and interferes with removal of the target material by one of the rare earth-containing treatment element or non-rare earth-containing treatment element. The interferer is removed by the upstream treatment element to one or more of: 1) inhibit damage of the downstream treatment element by the interferer; 2) avoid, or at least substantially minimize, interference by the interferer with target material removal by the downstream treatment element; 3) reduce consumption of the downstream treatment element; and 4) prolong the useful life and/or increase the efficiency of the downstream treatment element.

As will be appreciated, each of the upstream and downstream elements can be the rare earth-containing treatment element, non-rare earth-containing treatment element, or a combination thereof. As will be further appreciated, the upstream and downstream elements may be performed in separate stages or steps or in common or different vessels or locations. As will be further appreciated, the upstream and downstream elements may be part of an integral structure, such as part of a common substrate or porous and/or permeable medium.

In other embodiments, the interferer is a material that can be removed by either the upstream or downstream element. Preferably, the interferer is more effectively and/or efficiently removed by the upstream element than the downstream element. Preferably, the upstream element has one or both of: 1) a greater removal capacity for the interferer than the downstream element; and/or 2) a better cost efficiency, compared to downstream element, for interferer removal than the upstream element.

In some embodiments, the downstream treatment element is more expensive than the upstream treatment element. Commonly, but not always, the downstream treatment element is the rare earth-containing treatment element. The rare earth-containing treatment element may contain one or both of insoluble and soluble rare earth-containing compositions. Non-limiting examples of soluble rare earth compositions include cerium(III) carbonate, nitrate, halide, sulfate, acetate, formate, perchlorate, or oxalate and cerium(IV) nitrate, ammonium sulfate, perchlorate, and sulfate. Cerium dioxide is a non-limiting example of an insoluble rare earth composition. An exemplary target material is arsenic. Non-limiting examples of interferers, for arsenic removal by a rare earth-containing treatment element, are phosphate, carbonate, bicarbonate, silicate, and/or a halogen.

In some embodiments, the downstream element could be quickly consumed and/or damaged by the interferer. In such instances, the downstream treatment element may have a limited capacity and/or ability to remove the interferer compared to the ability of the upstream treatment element. While not wanting to be limited by example, the downstream treatment element, comprising a non-rare earth-containing treatment element, may remove the interferer by an oxidation/reduction process, in which the removal process can be compromised and/or excessively consumed. For example, the interferer can destructively react with and/or poison the non-rare earth-containing treatment element's ability to remove a target material from the feed stream.

Preferably, more of the interferer is removed by the upstream treatment element than by the downstream treatment element. Similarly, more of the target material is removed by the downstream treatment element than by the upstream treatment element. It can be appreciated that the interferer is defined in relation to the target material. That is, an interferer for a first target material may or may not be an interferer for a second target material.

More preferably, the upstream treatment element removes at least most, if not all, of the interferer. Furthermore, at least most, if not all, of the target material is removed by the downstream treatment element.

Even more preferably, when the feed stream is contacted with the downstream treatment element, little, if any, of the interferer present in the feed stream one or more of: is removed by; reacts with; interferes with; poisons; and/or deactivates the downstream treatment element. Moreover, the ability of the downstream treatment element is not substantially impaired and/or inhibited by any interferer remaining in the feed stream after the feed stream is contacted with the upstream treatment element.

Preferably the fluid is a liquid, gas or mixture thereof. More preferably, the fluid is an aqueous solution.

### Feed Stream

The fluid containing the interferer and the target material is typically in the form of a feed stream 100. The feed stream 100 is treated to remove one or both of the interferer and target material, preferably both of the interferer and target material. The feed stream 100 can be an aqueous stream in the form of a waste stream, process stream, or natural or man-made body of water. Non-limiting examples of aqueous streams that can be effectively treated include potable water streams, wastewater treatment streams, and industrial feed, process, or waste streams, to name a few. The described processes, apparatuses, elements, and articles can be used to remove various interferers and/or target materials from solutions having diverse volume and flow rate characteristics and applied in a variety of fixed, mobile, and portable applications.

Generally, the feed stream 100 is an aqueous solution having a pH of at least about pH 1, more generally at least about pH 2, more generally at least about pH 3, more generally at least about pH 4, more generally at least about pH 5, and even more generally at least about pH 6, and a pH of no more than about pH 13, more generally of no more than about pH 12, more generally of no more than about pH 11, more generally of no more than about pH 10, more generally of no more than about pH 9, and even more generally of no more than about pH 8.

While portions of this disclosure describe the removal of an interferer and/or a target material from water, and particularly potable water streams, commonly by precipitation, such references are illustrative and are not to be construed as limiting. For example, the disclosed aspects, embodiments, and configurations can be used to treat fluids other than aqueous and/or water-containing fluids, such as gases, and non-water containing fluids, gases, liquids or mixtures thereof.

### The Target Materials

The target material can include a variety of inorganic, organic, and active and inactive biological materials (such as, living and non-living biological matter). The feed stream may contain one or more target materials. For example, the target material may be a combination, a mixture, or both a combination and mixture of one or more target materials. Furthermore, the target material can be present at any concentration. The concentration of the target material can vary depending on the target material composition and/or form and the feed stream type, temperature, and source.

The target material comprises one or more of an oxyanion; an industrial chemical or material; a chemical agent; a dye; a colorant; a dye intermediate; a halogen; an inorganic material; a silicon-containing material; virus; humic acid, tannic acid; a phosphorus-containing material (such as an organophosphorous); an organic material; a microbe; a pigment; a colorant; a lignin and/or flavanoid; a biological contaminant; a biological material; or a combination or mixture thereof.

### The Interferers

The interferer is preferably removed by the upstream treatment element, prior to removal of the target material by the downstream treatment element. It can be appreciated that the target material can comprise a single target material or a combination and/or mixture of differing target materials. Furthermore, the interferer may comprise a single interferer or a combination and/or mixture of various interferers. The target material is present in the feed stream at a target material concentration. Typically, the interferer is present under conditions that the interferer is more effectively and/or efficiently removed by the upstream treatment element than the downstream treatment element. Non-limiting examples of the conditions which affect the ability of the upstream treatment element to more effectively and/or efficiently remove the interferer relative the downstream treatment element are one or more of: the interferer concentration; the target material concentration, the feed stream properties (such as, temperature, volume, flow rate, etc.); the upstream treatment element (such as, processing conditions, removal process, and composition thereof); the downstream treatment element (such as, processing conditions, removal process, and composition thereof); the interferer chemical and properties; and the target material chemical and physical properties. The interferer has an interferer concentration in the feed stream. The interferer concentration can be substantially more than, about equal to, or substantially less than the target material concentration.

The interferer can comprise one or more of an oxyanion; an industrial chemical or material; a chemical agent; a dye; a colorant; a dye intermediate; a halogen; an inorganic material; a silicon-containing material; an active or inactive virus; humic acid, tannic acid; a phosphorus-containing material (such as an organophosphorous); an organic material; a microbe; a pigment; a colorant; a lignin and/or flavanoid; an active or inactive biological contaminant; a biological material; or a combination or mixture thereof. The feed stream may contain one or more interferers. For example, the interferer may be a combination, a mixture, or both a combination and mixture of one or more interferers. Furthermore, the interferer can be present at any concentration. The concentration of the interferer can vary depending on the interferer composition and/or form and the feed stream type, temperature, and source.

Halogens and/or halides are an exemplary class of interferer(s). The halogens and/or halides are typically present as an anion. Halide salts typically include an alkali or alkaline earth metal, hydrogen, or ammonium halides. The halogen may be in the form of an organo halogen, such as a halocarbon (such as an organofluorine compound, organochlorine compound, organobromine compound, or organoiodine compound). The halogen or halide typically includes fluorine, bromine, iodine, or astatine, with fluorine and astatine being more typical.

Silicon-containing materials are another exemplary class of interferer(s). The silicon-containing material(s) can be organic or inorganic silicon-containing compounds comprising silicon and oxygen, silicates being an exemplary class of compounds. A silicate is a silicon-bearing anion. The great majority of silicates are oxides. However, hexafluorosilicate ([SiF₆]²⁻) and other silicon-containing anions are also silicon-containing interferer(s) that can, under proper conditions, be removed by a rare earth-containing treatment element.

### Non-Rare Earth-Containing Treatment Element

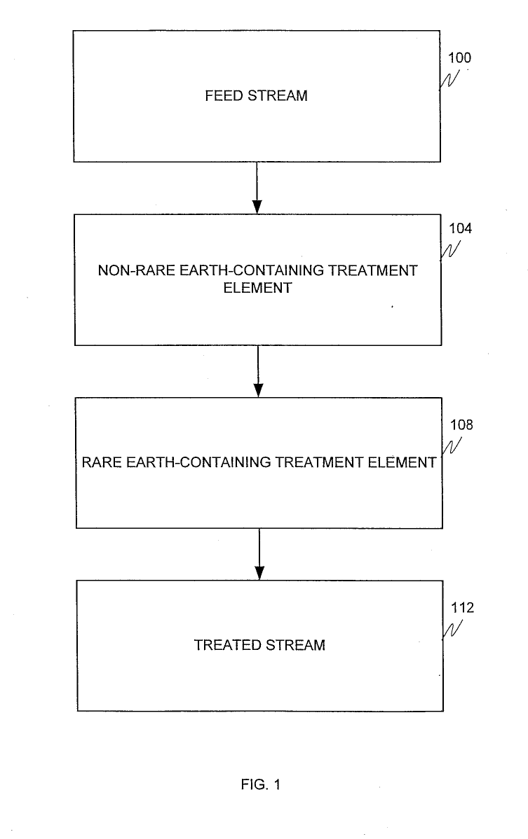

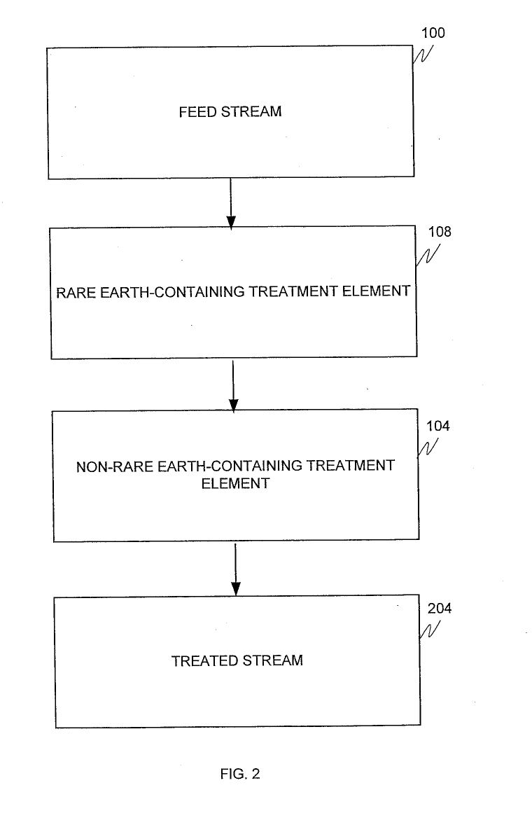

In a preferred embodiment, the non-rare earth-containing treatment 104 element does not include and/or incorporate (and/or is substantially free of) a rare earth. As described, the non-rare earth-containing treatment element 104 may be upstream or downstream of the rare earth-containing treatment element 108 as shown in FIGS. 1 and 2, respectively.

In embodiments having the non-rare earth-containing treatment element 104 upstream of the rare earth-containing treatment element 108, the non-rare earth-containing treatment element 104 removes at least some, if not most, of a material that interferes with removal by the rare earth-containing treatment element 108 of the target material passed by the non-rare earth-containing treatment element 104. It can be appreciated that, in such an embodiment, the non-rare earth-containing treatment element 104 passes, that is does not remove, at least most of the target material.

In embodiments having the non-rare earth-containing treatment element 104 downstream of the rare earth-containing treatment element 108, the non-rare earth-containing treatment element 104 removes at least some, if not most, of a target material passed by the rare earth-containing treatment element 108. It can be appreciated that in such an embodiment, the rare earth-containing treatment element 108 passes, that is does not remove, at least most of the target material and removes at least most of, if not all, of a material that interferes with removal by the non-rare earth-containing treatment element 104 of the target material.

The non-rare earth-containing treatment element 104 can remove one of the interferer or target material depending on whether the non-rare earth-containing treatment element 104 is, respectively, the upstream or downstream treatment element. The non-rare earth-containing treatment element 104 can be any suitable technique for removing one of interferer or target material. The technique can include precipitation by a sorbent or precipitant and/or pH adjustment, ion exchange, solvent extraction, membrane filtration, precipitation, complexation, cementation, oxidation (chemical or biological), reduction (chemical or biological), acidification, basification, electrolysis, radiation treatment, and the like. The filtration membrane can be of any suitable construction, such as a spiral wound module, tubular membrane, or hollow fiber membrane.

In some embodiments, the non-rare earth-containing treatment element 104 includes a membrane filter (e.g., leaky or tight RO filters, nanofilters, microfilters, membrane contractor, and ultrafilters), bed filtration, bag/cartridge filtration, resins, bone char, distillation, crystallation (as for example, by chilling), iron oxide coated sands, activated carbon, diatomaceous earth, alumina, gamma alumina, activated alumina, acidified alumina (e.g., alumina treated with an acid), metal oxides containing labile anions (e.g., aluminum oxychloride), crystalline alumino-silicates, such as zeolites, amorphous silica-alumina, ion exchange resins, clays such as bentonite, smectite, kaolin, dolomite, montmorillonite, and their derivatives, ferric salts, porous ceramics, silica gel, electrodialysis, electro-deionization, ozonation, chloride compounds, metal silicate materials and minerals such as of the phosphate and oxide classes, and combinations thereof. In particular, mineral compositions containing high concentrations of calcium phosphates, aluminum silicates, iron oxides and/or manganese oxides with lower concentrations of calcium carbonates and calcium sulfates may be suitable.

In some embodiments, the non-rare earth-containing treatment element 104 comprises one or more of a resin loaded with an amphoteric metal ion, typically in the form of a hydrous oxide; a biological oxidation in an aerobic medium and clarification; a coagulating agent chosen from metal salts of iron and/or of aluminum or salts of alkaline-earth metals; a polymer/iron salt admixture; a nonmetal silicate, such as a borosilicate; an iron oxide sorbent, a ferrous or ferric compound; an enzymatic composition; a biosorbent pretreated with anionic polymer and an iron salt; fly ash or an iron-containing slag, which may be activated by hydrated lime; and calcite and/or dolomite. One or more of these non-rare earth-containing treatment elements are preferred for removing a phosphorous-containing material.

In other embodiments, the non-rare earth-containing treatment element 104 includes acidification or basification of the feed stream with one of: an alkali, such as lime or soda ash (or other alkalis); sodium hydroxide; an organic acid; or inorganic acid, such as a mineral acid. One or more of these non-rare earth-containing treatment elements are preferred for removing a carbon and oxygen-containing material.

In yet other embodiments, the non-rare earth-containing treatment element 104 comprises one or more of: an aluminum-containing compound; a polystyrene based resin having iron oxide, alumina, an alkali or alkaline earth metal, fly ash, and/or a metal hydroxide; alum and/or an alkali or alkaline earth metal aluminate; a hydoxide ion-containing material (such as hydroxyapatite or a calcium phosphate/calcium hydroxide composite), preferably having at least some fluoride (or halide) ions substituted for the hydroxide ions in the material; a calcium compound (such as, calcium sulfate, lime, soda ash, calcium hydroxide, limestone, and other calcium sources) and one of ferric or aluminum salts; modified or activated alumina particles (the modified alumina particles containing alumina combined with iron or manganese, or both); calcium, carbonate, and phosphate sources; a macroporous, monodispersed, resin doped with iron oxide; a multivalent metal compound containing a multivalent metal (such as, Ca(II), Al(III), Si(IV), Ti(IV), and Zr(IV)) in the form of one of an oxide, hydrous oxide and/or basic carbonate; and amorphous iron and/or aluminum. One or more of these non-rare earth-containing treatment elements are preferred for removing a halogen-containing material.

In yet other embodiments, the non-rare earth-containing treatment element 104 comprises one or more of aluminum oxide, a mineral acid; iron oxide, iron, and/or a halogen-containing acid, such as HF, HCl, HBr, HI, or HAt. One or more of these non-rare earth-containing treatment elements are preferred for removing a silicon-containing material.

In still yet other embodiments, the non-rare earth-containing treatment element 104 comprises a radiative treatment element for removing one or both of the interferer and target material. While not wanting to be limited by theory, the interferer and/or target material being removed substantially absorbs and/or interacts with the radiative energy. The radiative energy substantially one of kills, destroys and/or transforms the interferer and/or target material. While not wanting to be limited by example, some microbes, viruses and biological materials can be removed by radiative energy.

The non-rare earth-containing treatment element 104 can comprise a chemical oxidant. The chemical oxidant can comprise one or more of ozone; peroxide; halogen; halogenate; perhalognate; halogenite; hypohalogenite; nitrous oxide, oxyanion; metal-containing oxide; peracid; superoxide; thiourea dioxide; diethylhydroxylamine; haloamine; halogen dioxide; polyoxide; and a combination and/or mixture thereof. The efficiency and/or capacity of the chemical oxidant can be pH dependent. More specifically, the oxidizing capacity and/or efficiency of one or more of halogen; halogenate; perhalognate; halogenite; hypohalogenite; oxyanion; peracid; superoxide; diethylhydroxylamine; haloamine; halogen dioxide; polyoxide; and a combination and/or mixture thereof can be pH dependent. Furthermore, the oxidation efficiency and/or capacity of hypochlorite are substantially affected by pH. Hypochlorite is typically an oxidant at a pH from about pH 5.5 to about pH 7.5. Moreover, chloramine formation and oxidizing efficiency is also affected by pH. For example, monochloramine (NH₂Cl) has a good oxidizing efficiency at a pH of no more than about pH7, while dichloroamine (NHCl₂) has a tolerable oxidizing efficiency at a pH from about pH 4 to about pH 7 and trichloramine (NCl₃) has an average oxidizing efficiency at a pH from about 1 to about pH 3. Regarding hypobromous acid and/or hybromite oxidizing efficiencies, pH values from about pH 6.5 to about pH 9 are preferred. Oxidative treatment systems based on a peroxone require a hydroxy radial (that is, OH⁻). Therefore, peroxone is less efficient at acidic (pH of less than about 7) and neutral (pH of from about pH 5 to about pH 9) pH values than basic pH values (pH values of no less than about pH 9). Peracid oxidative treatment systems are affected by one or both of temperature and pH. While not wanting to be limited by example, peracetic acid is more oxidative at a pH value of 7 than at pH values more than pH 8 or no more than pH 6. Furthermore, at a temperature of about 15 degrees Celsius (and at about pH 7) peracetic acid has an oxidative capacity one-fifth the oxidative capacity at about 35 degrees Celsius (and at about pH 7).

In another configuration, the non-rare earth-containing treatment element 104 can be an electrolytic treatment element. For example, the electrolytic treatment element can remove one or both of an interferer and/or target material by electrolytic deposition, electro-coagulation, electro-oxidation, electro-reduction and a combination thereof. Typically, the electrolytic treatment element is most effective and/or efficient for interferer(s) and/or target material(s) having a charge. In some instances, the electrolytic treatment element can also be suitable for interferer(s) and/or target materials having a substantially permanent or strong dipole moment and/or substantially strong and/or permanent surface charge.

In another configuration, the non-rare earth-containing treatment element 104 may comprise a copper-silver ionization treatment element. The copper-silver ionization treatment element comprises copper and silver ions dispersed in the fluid stream. The copper and silver ions electrostatically bond with cell walls and proteins of bacteria, viruses and fungi, disrupting the cellular proteins and enzymes of the microbes. This disruption eventually causes the bacteria, viruses and fungi to die. The copper-silver ionization treatment process typically requires at least about 30 to 50 days to substantially remove microorganisms from a fluid stream. Furthermore, the copper-silver ionization treatment process does not substantially remove interferers and/or target materials which are non-microorganisms, such as, but not limited to an oxyanion, industrial chemical or material, chemical agent, dye, colorant, a dye intermediate, halogen, inorganic material, silicon-containing material, humic acid, tannic acid, phosphorus-containing material, organic material, pigment, colorant, lignin and/or flavanoid, or combination thereof.

In one configuration, the non-rare earth-containing treatment element 104 can comprise a sorbtion (that is adsorption, absorption and/or precipitation) process. The sorbtion process can effected using a suitable sorbent, such as alumina, gamma-alumina, activated alumina, acidified alumina (such as alumina treated with hydrochloric acid), metal oxides containing labile anions (such as aluminum oxychloride), crystalline alumino-silicates (such as zeolites), amorphous silica-alumina, ion exchange resins, clays (such as montmorillonite), ferric sulfate, and porous ceramics.

In yet another configuration, non-rare earth-containing treatment element 104 can include a biocide or other material to deactivate, kill, or otherwise remove biological material and/or microbes. As will be appreciated, biocidal agents include alkali metals, alkaline earth metals, transition metals, actinides, and derivatives and mixtures thereof Specific, non-limiting examples of biocidal agents include elemental or compounds of silver, zinc, copper, iron, nickel, manganese, cobalt, chromium, calcium, magnesium, strontium, barium, boron, aluminum, gallium, thallium, silicon, germanium, tin, antimony, arsenic, lead, bismuth, scandium, titanium, vanadium, yttrium, zirconium, niobium, molybdenum, technetium, ruthenium, rhodium, palladium, cadmium, indium, hafnium, tantalum, tungsten, rhenium, osmium, iridium, platinum, gold, mercury, thallium, thorium, and the like. Derivatives of such agents can include acetates, ascorbates, benzoates, carbonates, carboxylates, citrates, halides, hydroxides, gluconates, lactates, nitrates, oxides, phosphates, propionates, salicylates, silicates, sulfates, sulfadiazines, quaternary ammonium salts, organosilicon compounds, polyoxometalates, and combinations thereof.

In still yet other configurations, the non-rare earth-containing treatment element 104 can include a decontamination agent capable for removing one and/or both of an interferer and target agent. For example, the decontamination agent can physically remove the interferer or target material, detoxify the interferer or target material or both remove and detoxify. Non-limiting examples of decontamination agents that may be suitable include transition metals and alkaline metals, polyoxometallates, aluminum oxides, quaternary ammonium complexes, zeolites, bacteria, enzymes and combinations thereof.

In still yet other configurations, the non-rare earth-containing element 104 can include a reductant for removing the interferer and/or target material. Non-limiting examples of suitable reductants comprises one or more of alcohol dehydrogenase, borane-containing material (including diboranes, catecholboranes, and borane complexes), daucus carota, metal (such as, but not limited to, low valence or zero valence zinc, indium(III), lithium, magnesium, manganese, nickel, copper, copper(II), chromium(II) iron, iron(II)), hydride-containing material (including borohydrides and triacetoxyborohydrides), formaldehyde, formic acid, hydrazine, hydrogen, dithionite-containing material, hydrosulfite-containing material, tetrahydroborate-containing material, phosphite-containing material, phosphine-containing material, silane-containing material (including siloxanes), and combinations thereof. It can be appreciated that reductants may not effectively and/or efficiency remove interferers and/or target materials, which are: 1) in a reduced state and/or 2) substantially inhibited or unable, due to the chemical or physical conditions, to receive an electron donated by the reductant.

As will be appreciated, other devices, materials and/or processes may be employed. As will be further appreciated, the various techniques disclosed can be arranged in any combination or order, simultaneously or upstream of the rare earth treatment element.

### The Rare Earth-Containing Treatment Element

The rare earth-containing treatment element 108 comprises a rare earth and/or rare earth-containing composition. As described above, the rare earth-containing treatment element 108 may be upstream or downstream of the non-rare earth-containing treatment element 104.

In embodiments having the rare earth-containing treatment element 108 upstream of the non-rare earth-containing treatment element 104, the rare earth-containing treatment element 108 removes at least some, if not most, of a material that interferes with removal by the non-rare earth-containing treatment element 104 of the target material passed by the rare earth-containing treatment element 108. In can be appreciated that in such an embodiment, the rare earth-containing treatment element 108 passes, that is does not remove, at least most of the target material.

In embodiments having the rare earth-containing treatment element 108 downstream of the non-rare earth-containing treatment element 104, the rare earth-containing treatment element 108 removes at least some, if not most, of a target material passed by non-rare earth-containing treatment element 104. In can be appreciated that in such an embodiment, the non-rare earth-containing treatment element 104 passes, that is does not remove, at least most of the target material and removes at least most, if not all, of a material that interferes with the removal by the rare earth-containing treatment element 108 of the target material.

The rare earth-containing treatment element 108 can remove one of the interferer or target material depending on whether the rare earth-containing treatment element 108 is, respectively, the upstream or downstream treatment element. The rare earth-containing treatment element 108 can be any suitable technique using a rare earth and/or rare earth-composition for removing one of interferer or target material.

The rare earth-containing treatment element 108 can remove one of the interferer or target material depending on whether the rare earth-containing treatment element 108 is, respectively, the upstream or downstream treatment element.

The rare earth and/or rare earth-containing composition in the rare earth-containing treatment element 108 can be rare earths in elemental, ionic or compounded form. The rare earth and/or rare earth-containing composition can be water soluble or insoluble. As discussed below, the rare earth and/or rare earth-containing composition can be in the form of nanoparticles, particles larger than nanoparticles, agglomerates, or aggregates or combination and/or mixture thereof. The rare earth and/or rare earth-containing composition can be supported or unsupported. The rare earth and/or rare earth-containing composition can comprise one or more rare earths. The rare earths may be of the same or different valence and/or oxidation states and/or numbers, such as the +3 and +4 oxidation states and/or numbers. The rare earths can be a mixture of different rare earths, such as two or more of yttrium, scandium, cerium, lanthanum, praseodymium, and neodymium. The rare earth and/or rare earth-containing composition preferably includes cerium(III) and/or (IV), with cerium(IV) oxide being preferred. In a particular formulation, the rare earth and/or rare earth-containing composition consists essentially of one or more cerium oxides (e.g., cerium(IV) oxide, cerium(III) oxide, and mixtures thereof) and/or of one or more cerium oxides in combination with other rare earths (such as, but not limited to one or more of lanthanum, praseodymium, yttrium, scandium, neodymium, samarium, europium, gadolinium, terbium, dysprosium, holmium, erbium, thulium, ytterbium and lutetium).

The rare earth and/or rare earth-containing composition is, in one application, not a naturally occurring mineral but is synthetically manufactured. Exemplary naturally occurring rare earth-containing minerals include bastnaesite (a carbonate-fluoride mineral) and monazite. Other naturally occurring rare earth-containing minerals include aeschynite, allanite, apatite, britholite, brockite, cerite, fluorcerite, fluorite, gadolinite, parisite, stillwellite, synchisite, titanite, xenotime, zircon, and zirconolite. Exemplary uranium minerals include uraninite (UO₂), pitchblende (a mixed oxide, usually U₃O₈), brannerite (a complex oxide of uranium, rare-earths, iron and titanium), coffinite (uranium silicate), carnotite, autunite, davidite, gummite, torbernite and uranophane. In one formulation, the rare earth and/or rare earth-containing composition is substantially free of one or more elements in Group 1, 2, 4-15, or 17of the Periodic Table, a radioactive species, such as uranium, sulfur, selenium, tellurium, and polonium.

The rare earth and/or rare earth-containing composition may be formulated as a water-soluble composition. In one formulation, the rare earth-containing composition is water-soluble and preferably includes one or more rare earths, such as cerium and/or lanthanum, the rare earth(s) having a +3 oxidation state. Non-limiting examples of suitable water soluble rare earth compounds include rare earth halides, rare earth nitrates, rare earth sulfates, rare earth oxalates, rare earth perchlorates, and mixtures thereof.

The rare earth and/or rare earth-containing composition may be in the form of one or more of a granule, powder, crystal, crystallite, particle and particulate. Furthermore, it can be appreciated that the agglomerated and/or aggregated forms of rare earth and/or rare earth-containing compositions may be in the form of one or more of a granule, powder, particle, and particulate.

The rare earth-containing composition may comprise crystals or crystallites and be in the form of a free-flowing granule, powder, and/or particulate. Typically the crystals or crystallites are present as nanocrystals or nanocrystallites. Typically, the rare earth powder has nanocrystalline domains. The rare earth powder may have a mean, median, and/or P₉₀ particle size of at least about 0.5 nm, ranging up to about 1 μm or more. More typically, the rare earth granule, powder and/or particle has a mean particle size of at least about 1 nm, in some cases at least about 5 nm, in other cases, at least about 10 nm, and still other cases at least about 25 nm, and in yet still other cases at least about 50 nm. In other embodiments, the rare earth powder has a mean, median, and/or P₉₀ particle size in the range of from about 50 nm to about 500 microns and in still other embodiments in the range of from about 50 nm to about 500 nm. The powder is typically at least about 75 wt. %, more typically at least about 80 wt. %, more typically at least about 85 wt. %, more typically at least about 90 wt. %, more typically at least about 95 wt. %, and even more typically at least about 99 wt. % of rare earth compound(s).

The rare earth-containing composition may be formulated as a rare earth-containing agglomerate or aggregate. The agglomerates or aggregates can be formed through one or more of extrusion, molding, calcining, sintering, and compaction. In one formulation, the rare earth-containing composition 108 is a free-flowing agglomerate comprising a binder and a rare earth powder having nanocrystalline domains. The agglomerates or aggregates can be crushed, cut, chopped or milled and then sieved to obtain a desired particle size distribution. Furthermore, the rare earth powder may comprise an aggregate of rare earth nanocyrstalline domains. Aggregates can comprise rare earth-containing particulates aggregated in a granule, a bead, a pellet, a powder, a fiber, or a similar form.

In a preferred agglomerate or aggregate formulation, the agglomerates or aggregates include an insoluble rare earth composition, preferably, cerium(III) oxide, cerium(IV) oxide, and mixtures thereof, and a soluble rare earth composition, preferably a cerium(III) salt (such as cerium(III) carbonate, cerium(III) halides, cerium(III) nitrate, cerium(III) sulfate, cerium(III) oxalates, cerium(III) perchlorate, cerium(IV) salts (such as cerium(IV) oxide, cerium(IV) ammonium sulfate, cerium(IV) acetate, cerium(IV) halides, cerium(IV) oxalates, cerium(IV) perchlorate, and/or cerium(IV) sulfate), and mixtures thereof) and/or a lanthanum(III) salt or oxide (such as lanthanum(III) carbonate, lanthanum(III) halides, lanthanum(III) nitrate, lanthanum(III) sulfate, lanthanum(III) oxalates, lanthanum(III) oxide, and mixtures thereof).

The binder can include one or more polymers selected from the group consisting of thermosetting polymers, thermoplastic polymers, elastomeric polymers, cellulosic polymers and glasses. Binders include polymeric and/or thermoplastic materials that are capable of softening and becoming “tacky” at elevated temperatures and hardening when cooled. The polymers forming the binder may be wet or dry. Furthermore, the polymers forming the binder may be provided in the form of an imvision and/or depression.

The preferred mean, median, or P₉₀ size of the agglomerate or aggregates depend on the application. In most applications, the agglomerates or aggregates preferably have a mean, median, or P₉₀ size of at least about 1 μm, more preferably at least about 5 μm, more preferably at least about 10 μm, still more preferably at least about 25 μm. In other applications, the agglomerate has a mean, median, or P₉₀ particle size distribution from about 100 to about 5,000 microns, a mean, median, or P₉₀ particle size distribution from about 200 to about 2,500 microns, a mean, median, or P₉₀ particle size distribution from about 250 to about 2,500 microns, or a mean, median, or P₉₀ particle size distribution from about 300 to about 500 microns. In other applications, the agglomerates or aggregates can have a mean, median, or P₉₀ particle size distribution of at least about 100 nm, specifically at least about 250 nm, more specifically at least about 500 nm, still more specifically at least about 1 μm and yet more specifically at least about 0.5 nm, ranging up to about 1 micron or more. Specifically, the rare earth particulates, individually and/or agglomerated or aggregated, can have a surface area of at least about 5 m²/g, in other cases at least about 10 m²/g, in other cases at least about 70 m²/g, in other cases at least about 85 m²/g, in other cases at least about 100 m²/g, in other cases at least about 115 m²/g, in other cases at least about 125 m²/g, in other cases at least about 150 m²/g, in still other cases at least 300 m²/g, and in yet other cases at least about 400 m²/g.

The agglomerate or aggregate composition can vary depending on of the agglomeration or aggregation process. Preferably, the agglomerates or aggregates include more than 10.01 wt %, even more preferably more than about 75 wt %, and even more preferably from about 80 to about 95 wt % of the rare earth-containing composition, with the balance being primarily the binder. Stated another way, the binder can be less than about 15% by weight of the agglomerate, in some cases less than about 10% by weight, in still other cases less than about 8% by weight, in still other cases less than about 5% by weight, and in still other cases less than about 3.5% by weight of the agglomerate or aggregate.

In another formulation, the rare earth-containing treatment element includes nanocrystalline rare earth particles supported on, coated on, or incorporated into a substrate. The nanocrystalline rare earth particles can, for example, be supported or coated on the substrate by a suitable binder, such as those set forth above. Substrates can include porous and fluid permeable solids having a desired shape and physical dimensions. The substrate, for example, can be a sintered ceramic, sintered metal, microporous carbon, glass fiber, cellulosic fiber, alumina, gamma-alumina, activated alumina, acidified alumina, metal oxide containing labile anions, crystalline alumino-silicate such as a zeolite, amorphous silica-alumina, ion exchange resin, clay, ferric sulfate, porous ceramic, and the like. Such substrates can be in the form of mesh, as screens, tubes, honeycomb structures, monoliths, and blocks of various shapes, including cylinders and toroids. The structure of the substrate will vary depending on the application but can include a woven substrate, non-woven substrate, porous membrane, filter, fabric, textile, or other fluid permeable structure. The rare earth and/or rare composition in the rare earth-containing treatment element can be incorporated into or coated onto a filter block or monolith for use in a filter, such as a cross-flow type filter. The rare earth and/or rare earth-containing composition can be in the form of particles coated on to or incorporated in the substrate or can be ionically substituted for cations in the substrate.

The amount of rare earth and/or rare earth-containing composition in the rare earth-containing treatment element can depend on the particular substrate and/or binder employed. Typically, the target material removal element includes at least about 0.1% by weight, more typically 1% by weight, more typically at least about 5% by weight, more typically at least about 10% by weight, more typically at least about 15% by weight, more typically at least about 20% by weight, more typically at least about 25% by weight, more typically at least about 30% by weight, more typically at least about 35% by weight, more typically at least about 40% by weight, more typically at least about 45% by weight, and more typically at least about 50% by weight rare earth and/or rare earth-containing composition. Typically, the rare earth-containing treatment element includes no more than about 95% by weight, more typically no more than about 90% by weight, more typically no more than about 85% by weight, more typically no more than about 80% by weight, more typically no more than about 75% by weight, more typically no more than about 70% by weight, and even more typically no more than about 65% by weight rare earth and/or rare earth-containing composition.

It should be noted that it is not required to formulate the rare earth-containing composition with either a binder or a substrate, though such formulations may be desired depending on the application.

### Upstream Treatment Element

The upstream treatment element commonly removes at least most, more commonly at least about 65%, more commonly at least about 75%, more commonly at least about 85%, more commonly at least about 90%, and even more commonly at least about 95% of the interferer. Substantial removal of the interferer renders it less preferentially removed by the downstream treatment element. The concentration of the interferer in the feed stream after contacting the feed stream with the upstream treatment element is maintained at a concentration typically of no more than about 300 ppm, more typically no more than about 250 ppm, more typically no more than about 200 ppm, more typically no more than about 150 ppm, more typically no more than about 100 ppm, more typically no more than about 50 ppm, and even more typically no more than about 10 ppm of the interferer. In some configurations, the concentration of the interferer is maintained at a concentration typically of no more than about 500 ppb, more typically no more than about 250 ppb, more typically no more than about 200 ppb, more typically no more than about 150 ppb, more typically no more than about 100 ppb, more typically no more than about 50 ppb, and even more typically no more than about 10 ppb of the interferer. In some embodiments, the upstream treatment element does not include and/or incorporate (and/or is substantially free of) a rare earth. In other embodiments, the upstream treatment element includes and/or incorporates a rare earth and/or rare earth-containing composition.

Preferably, the upstream treatment element has a much higher removal capacity and/or preference for removing the interferer than the downstream treatment element and/or the downstream treatment element has a much higher removal capacity and/or preference for the removing the target material than the upstream treatment element. For example, the removal capacity and/or preference of the upstream treatment element for the interferer can be more than about 1.5 times, more commonly more than about 2 times, more commonly more than about 2.5 times, and even more commonly more than about 3 times of the removal capacity and/or preference for the target material. A preference and/or removal capacity of the downstream treatment element for the interferer can be more than about 1.5 times, more commonly more than about 2 times, more commonly more than about 2.5 times, and even more commonly more than about 3 times of the capacity and/or preference of the downstream treatment element for the target material(s). Furthermore, the removal capacity and/or preference of the downstream treatment element for the interferer can be no more than about 1.0 times, more commonly no more than about 0.9 times, more commonly no more than about 0.5 times, and even more commonly more than about 0.1 times of the capacity and/or preference of the upstream treatment element for the interferer. Moreover, the capacity and/or preference of the downstream treatment element for the target material(s) can be more than about 1.5 times, more commonly more than about 2 times, more commonly more than about 2.5 times, and even more commonly more than about 3 times of the capacity and/or preference of the upstream treatment element for the target material(s). Similarly, the removal capacity and/or preference of the upstream treatment element for the target material can be no more than about 1.0 times, more commonly no more than about 0.9 times, more commonly no more than about 0.5 times, and even more commonly more than about 0.1 times of the capacity and/or preference of the downstream treatment element for the target material.

In some embodiments, the upstream treatment element can remove at least some, if not at least most, of one or more target materials from the treatment stream. In one configuration, the downstream treatment element can remove any of the one or more target materials remaining in the feed stream after the contacting of the feed stream with the upstream treatment element. In another configuration, the upstream treatment element removes at least some, if not at least most, of one or more target materials from the treatment stream, while passing at least most of other target materials. In such a configuration, the downstream treatment element can remove at least most, if not substantially all, of other target materials and any of the one or more target materials remaining in the feed stream after the contacting of the feed stream with the upstream treatment element. In these embodiments and/or configurations, the downstream treatment element further purifies and/or polishes the feed stream after the contacting of the feed stream with the upstream treatment element. Furthermore, in these embodiments and/or configurations, the upstream treatment element can remove the one or more target elements and/or the other target materials, respectively, at any one of the removal levels indicated below for the downstream treatment element.

### Downstream Treatment Element

The downstream treatment element commonly removes at least most, more commonly at least about 65%, more commonly at least about 75%, more commonly at least about 85%, more commonly at least about 90%, and even more commonly at least about 95% of the target material. Substantially little, if any, of the target material is removed from the feed stream by the upstream treatment element. The concentration of the target material in the feed stream after contacting the feed stream with the downstream treatment element is maintained at a concentration typically of no more than about 300 ppm, more typically no more than about 250 ppm, more typically no more than about 200 ppm, more typically no more than about 150 ppm, more typically no more than about 100 ppm, more typically no more than about 50 ppm, and even more typically no more than about 10 ppm of the target material. In some configurations, the concentration of the target material is maintained at a concentration typically of no more than about 500 ppb, more typically no more than about 250 ppb, more typically no more than about 200 ppb, more typically no more than about 150 ppb, more typically no more than about 100 ppb, more typically no more than about 50 ppb, and even more typically no more than about 10 ppb of the target material.

### Treatment Configurations

One or both of the upstream and downstream treatment elements can comprise one or more of: a fixed or fluidized bed; a stirred, tank or pipe reactor, vessel; a monolith, and a filtering device, configuration or apparatus (such as, a membrane, block, pad, bed, column or container, and the like).

In one embodiment shown in FIG. 2, the rare earth-containing treatment element 108 is upstream of the non-rare earth-containing treatment element 104. The feed stream 100 is contacted with the rare earth-containing treatment element 108 and, thereafter, the feed stream 100 is contacted with the non-rare earth-containing treatment element 104 to form a treated stream 204. Preferably, the rare earth-containing treatment element 108 removes an interferer of the non-rare earth-containing treatment element 104. More preferably, the non-rare earth-containing treatment element 104 removes a target material substantially passed (that is, not substantially removed) by the rare earth-containing element 108. Even more preferably, the rare earth-containing treatment element 108 removes an interferer of the non-rare earth-containing treatment element 104 and the non-rare earth-containing treatment element 104 removes a target material substantially passed (that is, not substantially removed) by the rare earth-containing treatment element 108.

In another embodiment, the non-rare earth-containing treatment element 104 is upstream of the rare earth-containing treatment element 108. The feed stream 100 is contacted with the non-rare earth-containing treatment element 104 and, thereafter, the feed stream 100 is contacted with the rare earth-containing treatment element 108 to form a treated stream 112. Preferably, the non-rare earth-containing treatment element 104 removes an interferer of the rare earth-containing treatment element 108. More preferably, the rare earth-containing treatment element 108 removes at a target material substantially passed (that is, not substantially removed) by the non-rare earth-containing material 104. Even more preferably, the non-rare earth-containing treatment element 104 removes an interferer of the rare earth-containing treatment element 108 and the rare earth-containing treatment element 108 removes a target material substantially passed (that is, not substantially removed) by the non-rare earth-containing material 104.

The treated stream 112 or 204 is in compliance with desired requirements (such as regulatory, process engineering, or economic requirements). As will be appreciated, the treated stream 112 or 204 may be subjected to further treatment operations to remove the same, additional and/or different interferers and/or target materials. These further treatment options may be upstream, downstream or both upstream and downstream of one or both of the rare earth-containing treatment element and the non-rare earth-containing treatment element. For example, a fluid solid separation process, to remove large particulate matter (such as sand, solid refuse, dirt, silt and such) from the feed stream 100 may be upstream of both the rare earth-containing and the non-rare earth-containing treatment elements 108 and 104. In another example, the non-rare earth-containing treatment element 104 comprises a membrane, which forms a permeate and a retentate. The permeate may be contacted with the rare earth-containing treatment element 108 to form the treated stream 112 and the retentate may be subjected to a further treatment option.

### Rare Earth-Containing Treatment Element Upstream of Non-Rare Earth-Containing Treatment Element

In one embodiment, the rare earth containing treatment element 108 is upstream of a non-rare earth-containing treatment element 104 comprising an oxidative treatment element. The oxidative treatment element removes one or more target materials from the feed stream by oxidizing at least some, if not most, of one or more target material(s). Non-limiting examples of an oxidative treatment element comprise elements having and/or generating one or more of the following an oxidizing material: ozone; peroxide (includes any compound containing the —O—O— linkage, such as, but not limited to, R—O—O—R′, the R and R′ may vary independently and may comprise a hydrogen radical and a carbon-containing radial); halogen (such as, fluorine, F₂, chlorine, Cl₂, bromine, Br₂, iodine, I₂, astatine, At₂, or a mixture thereof); halogenate (such as, chlorate, ClO₃⁻, bromate, BrO₃⁻, iodate, IO₃⁻, and astate, AtO₃⁻, or a mixture thereof); perhalognate (such as, perchlorate, ClO₄⁻, perbromate, BrO₄⁻, periodate, IO₄⁻, and perastate, AtO₄⁻, or a mixture thereof); halogenite (such as, chlorite, ClO₂⁻, bromite, BrO₂⁻, iodite, IO₂⁻, and astite, AtO₂⁻, or a mixture thereof); hypohalogenite (such as, hypochlorite, ClO⁻, hypobromite, BrO⁻, hypoiodite, IO⁻, and hypoastite, AtO⁻, or a mixture thereof); nitrous oxide, oxyanion (such as defined above and including permanganate, chromic chromate, pyridium chlorochromate, and a mixture thereof); metal-containing oxide (such as, but not limited to osmium tetraoxide, chromium trioxide, and a mixture thereof); peracid (such as, but not limited to persulfate, persulfuric acid, peracetic acid, perbromic acid, perbromate, perborate, percarbonate, and a mixture thereof); superoxide (includes any materials containing O₂⁻); thiourea dioxide; diethylhydroxylamine; haloamine (such as chloroamine, bromamine, iodamine, astamine, and a mixture thereof); halogen dioxide (such as chlorine dioxide, ClO₂, bromine dioxide, BrO₂, iodine dioxide, IO₂, astatine dioxide, AtO₂, and a mixture thereof); polyoxide (such as trioxidane (H₂O₃), peroxone (H₂O₅), and a mixture thereof), and a combination and/or mixture thereof.

In one configuration, the rare earth-containing treatment element 108 is upstream of the oxidative and/or reductive treatment element to protect the oxidative and/or reductive treatment element from excessive oxidation, reduction, and/or poisoning. The rare earth-containing treatment element 108 can remove an interferer and/or target material not removed by the non-rare earth-containing treatment element 104. For example, some interferers, such as organic chemicals and materials, can be oxidized or reduced but not removed by the oxidative and/or reductive treatment element. The oxidization and/or reduction of the organic chemicals and materials excessively consume the oxidative and/or reductive treatment material without providing a sufficiently treated stream. In one configuration, the rare earth-containing treatment element 108 removes at least most of one or more of arsenic, tannic acid, humic acid and oxyanions from the feed stream prior to contacting the feed stream 100 with the oxidative and/or reductive treatment element. In one preferred configuration, the rare earth-containing treatment element 108 comprises cerium oxide, preferably cerium(IV) dioxide (CeO₂). In another preferred configuration, the oxidative treatment element comprises a halogen-containing composition or a composition that produces a halogen-containing composition. Preferably, the halogen-containing composition is one of chlorine-containing and/or bromine-containing composition. In a more preferred embodiment, the rare earth-containing treatment element 108 comprises cerium oxide, preferably cerium(IV) dioxide (CeO₂) and the oxidative treatment element comprises a halogen-containing composition or a composition that produces a halogen-containing composition, preferably the halogen-containing composition is one of chlorine-containing and/or bromine-containing composition. Removing the interferer with the rare earth-containing treatment element 108 upstream of the non-rare earth-containing treatment element 104 substantially preserves the non-rare earth-containing treatment element 108. Furthermore, removing target materials from the feed stream 100 that are not substantially, if at all, removed by the oxidative treatment element products a higher quality treated stream 204. The higher quality treated stream 204 contains substantially less of at least one of an oxyanion, an industrial chemical or material, a chemical agent, a dye, a colorant, a dye intermediate, a halogen, an inorganic material, a silicon-containing material, virus, humic acid, tannic acid, a phosphorus-containing material, an organic material, a microbe, a pigment, a colorant, a lignin and/or flavanoid, and an active or inactive biological material.

In one embodiment, the rare earth containing treatment element 108 is upstream of a non-rare earth-containing treatment element 104 comprising a membrane. The membrane removes one or more target materials from the feed stream 100 as described above. The interferer can affect the separation efficiency and/or capacity of the membrane. For example, the membrane can be damaged by halogens and halogen-containing compounds, such as those described herein. Furthermore, one or more of an organic chemical, a microorganism and combinations thereof can damage the membrane. Non-limiting examples of the organic chemicals that can damage the membrane are industrial chemicals or materials, chemical agents, dyes, colorants, dye intermediates, humic acid, tannic acid, organic materials, pigments, colorants, lignins and/or flavanoids, and combinations and/or mixtures thereof. Regarding microorganisms, non-limiting examples of the microorganisms that can damage the membrane are microbes and biological materials.

In one configuration, the rare earth-containing treatment element 108 removes at least most of one or more interferer that can damage the membrane. The interferer that can damage the membrane is selected from the group consisting of halogens and halogen-containing compounds, microorganisms, organic materials, industrial chemicals or materials, chemical agents, dyes, colorants, dye intermediates, humic acid, tannic acid, pigments, colorants, lignins and/or flavanoids, oxyanions, microbes and active or inactive biological materials. It can be appreciated that some membranes can separate some oxyanions and that some oxyanions can damage some membranes. Oxyanions that can damage some membranes can comprise oxyanions that can chemically react with the membrane (such as chemically transform by the membrane by forming a chemical bond with the membrane) and/or physically interact with the membrane. The physical interaction differs from a physical separation of oxyanion by the membrane. Non-limiting examples of physical interactions that can damage the membrane are membrane plugging, swelling, embrittling, and blinding to name a few. In one preferred configuration, the rare earth-containing treatment element comprises cerium oxide, preferably cerium(IV) dioxide (CeO₂). In another preferred configuration, the membrane is protected from an interferer that can damage the membrane. In a more preferred embodiment, the cerium oxide, preferably cerium(IV) dioxide (CeO₂) removes the membrane damaging interferer from the feed stream 100 prior to the feed stream 100 being contacted with the membrane.

In another configuration, the rare earth-containing treatment element 108 is upstream of a non-rare earth-containing treatment element 104 comprising a copper/silver ionization treatment element. The rare earth-containing treatment element 108 substantially removes one or both of an interferer of the copper/silver ionization treatment element and target materials not removed by the copper/silver ionization process. Non-limiting examples of interferers are: oxyanions that can be precipitated with a cation of copper or silver. Common oxidation states of copper are Cu¹⁺, Cu²⁺, Cu³⁺ and Cu⁴⁺. The common oxidation states of silver are Ag⁺, Ag²⁺ and Ag³⁺. Non-limiting examples of oxyanion interferers are halogens, halides (e.g., silver chloride), sulfides (e.g., silver and copper sulfides), thiols (e.g., silver and copper thiols), and mixtures thereof. Exemplary oxyanion interferers include sulfur, phosphorus, molybdenum, arsenic, boron, carbon, and chromium-containing oxyanions because they form insoluble complexes with a member of Group IB of the Periodic Table (e.g., copper, silver, and gold). In one preferred configuration, the rare earth-containing treatment element 108 comprises cerium oxide, preferably cerium(IV) dioxide (CeO₂). In a more preferred embodiment, the cerium oxide, preferably cerium(IV) dioxide (CeO₂) substantially removes one or more oxyanions that can form substantially insoluble compositions with cations of one or both copper and silver. Removing the interferer with the rare earth-containing treatment element upstream of the copper/silver ionization treatment element substantially preserves the removal ability of the copper/silver ionization treatment element.

In yet another configuration, the non-rare earth-containing treatment element 104 comprises a chlorine dioxide process downstream of the rare earth-containing treatment element 108. The chlorine dioxide treatment element neither substantially removes escherichia coli nor rotaviruses. The rare earth-containing treatment element 108 substantially removes one or both of the escherichia coli and rotaviruses prior to contacting the feed stream 100 with the chlorine dioxide treatment element. Preferably, the rare earth-containing treatment element 108 comprises an insoluble rare earth-containing composition. More preferably the insoluble rare earth-containing composition comprises cerium(IV) oxide, even more preferably cerium dioxide (CeO₂).

In yet another configuration, the rare earth-containing treatment element 108 is upstream of a non-rare earth-containing treatment element 104 comprising a peroxide process. The rare earth-containing treatment element 108 substantially removes one or both of an interferer of the peroxide process and target materials not removed by the peroxide process. For example, peroxides can generate molecular oxygen. The generated molecular oxygen can accelerate microbial growth. While not wanting to be limited by example, the rare earth-containing treatment element 108 can remove any interferer that substantially generates molecular oxygen when contacted with the peroxide.

In another configuration, the rare earth-containing treatment element 108 is upstream of a non-rare earth-containing treatment element 104 comprising an electrolytic treatment unit. The interferer can co-deposit on a common anode or cathode with the target material. Examples are metals from a common group of the Periodic Table of the Elements, such as copper and gold. The interferer can be removed by the rare earth-containing treatment element as an oxyanion.

In another configuration, the rare earth-containing treatment element 108 is upstream of a non-rare earth-containing treatment element 104 comprising a biocide. The interferer reacts with or consumes or otherwise neutralizes the biocide.

In another configuration, the rare earth-containing treatment element 108 is upstream of a non-rare earth-containing treatment element 104 comprising a decontamination agent. The interferer reacts with or consumes or otherwise neutralizes the decontamination agent.

Phosphorous-containing compositions are an example of interferers that can be removed by a rare earth-containing treatment element 108, the phosphate-containing composition being an interferer for a non-rare earth-containing treatment element 104. Non-limiting examples of non-rare earth-containing treatment elements 104 that can have phosphorous-containing composition interferers are membranes, oxidative processes, reductive processes, a resin-based process, an electrolytic process and/or a biocidal process. The rare earth-containing treatment element 108 can comprise a soluble rare earth-containing composition, an insoluble rare earth-containing composition or a combination thereof Preferably, the rare earth-containing treatment element 108 removes the phosphorous-containing composition by forming a substantially insoluble or sorbed composition comprising a rare earth and phosphorous.

Compositions containing carbon and oxygen are examples of an interferer that can be removed by a rare earth-containing treatment element 108, the carbon and oxygen composition being an interferer for a non-rare earth-containing treatment element 104. Non-limiting examples of non-rare earth-containing treatment elements 104 that can have carbon and oxygen composition interferers are membranes, oxidative processes, reductive processes, a resin-based process, an electrolytic process and/or a biocidal process. The rare earth-containing treatment element 108 can comprise a soluble rare earth-containing composition, an insoluble rare earth-containing composition or a combination thereof Preferably, the rare earth-containing treatment element 108 removes the carbon and oxygen composition by forming a substantially insoluble or sorbed composition comprising a rare earth and the carbon and oxygen composition.

Halogen-containing compositions are an example of interferers that can be removed by a rare earth-containing treatment element 104, the halogen-containing composition being an interferer for a non-rare earth-containing treatment element 104. Non-limiting examples of non-rare earth-containing treatment elements that can have halogen-containing composition interferers are membranes, oxidative processes, reductive processes, a resin-based process, an electrolytic process and/or a biocidal process. The rare earth-containing treatment element 108 can comprise a soluble rare earth-containing composition, an insoluble rare earth-containing composition or a combination thereof. Preferably, the rare earth-containing treatment element removes the halogen-containing composition by forming a substantially insoluble or sorbed composition comprising a rare earth and a halogen.

Silicon-containing compositions are an example of interferers that can be removed by a rare earth-containing treatment element 108, the silicon-containing composition being an interferer for a non-rare earth-containing treatment element 104. Non-limiting examples of non-rare earth-containing treatment elements 104 that can have silicon-containing composition interferers are membranes, oxidative processes, reductive processes, a resin-based process, an electrolytic process and/or a biocidal process. Preferably, the silicon-containing composition is a silicate. The rare earth-containing treatment element 108 can comprise a soluble rare earth-containing composition, an insoluble rare earth-containing composition or a combination thereof. Preferably, the rare earth-containing treatment element 108 removes the halogen-containing composition by forming a substantially insoluble or sorbed composition comprising a rare earth and silicon.

In yet another configuration, the non-rare earth-containing treatment element is an ion exchange medium, whether anionic, cationic, or amphoteric, and the target material and interferer are competing ions for sites on the ion exchange medium. As noted, the set of ions that will be sorbed by a selected resin depends on the size of the ions, their charge, and/or their structure. Generally, ions with higher valence, greater atomic weights and smaller radii are preferred by ion exchange resins and adsorption media. Competing ions can lead to a reduction in capacity for the target contaminant. When the capacity of the ion exchange resin is exhausted, it is necessary to regenerate the resin using a saturated solution of the exchange ion or counter ion (e.g., Na⁺ or Cl⁺) and/or replacement of the resin.

There are many examples of target materials and interferers for ion exchange resins. For example, perchlorate, sulfate, carbonate, bicarbonate, and nitrate ions are competing ions for many ion exchange resins, such as Type I styrene resins and nitrate selective resins. Radionuclides (e.g., Ra²⁺), other polyvalent ions (such as barium, strontium, calcium, and magnesium) or oxyanions thereof, and sulfate ions are competing ions for certain ion exchange resins. Metal cations or oxyanions thereof having a similar charge, atomic weight, and/or radii can be competing ions depending on the resin.

The interferer can also be in the form of a foulant, which is typically an organic material. Examples of other foulants include particulates and metals (e.g., iron and manganese).

As noted, cerium(IV) oxide can remove interferers, such as sulfates, organic materials, halogens, and halides before ion exchange treatment to remove a target material, such as perchlorate, mono or polyvalent metal ions, and other target materials. For metal cations as interferers, the metal cations can be contacted with an oxidant (e.g., molecular oxygen) and converted into oxyanions prior to contact with the rare earth-containing element, thereby facilitating or enabling cation removal by the rare earth composition.

In yet another configuration, the non-rare earth-containing treatment element is a solvent exchange unit and the interferer is an impurity that is soluble, with the target material, in the organic solvent or is reacts detrimentally with the organic solvent. For example, solvent extraction is able to remove Group VB elements (e.g., N, P, As, Sb, and Bi), Group IB elements (Cu, Ag, and Au), Group IIB elements (Zn, Cd, and Hg), Group IIIA elements (B, Al, Ga, In, and Tl) Group VIIIB elements (e.g., Fe, Ru, Os, Co, Rh, Ir, Ni, Pd, and Pt), and the actinides. The rare earth-containing treatment element can remove oxyanions of certain of these elements as discussed above, which would be considered to be impurities if recovered with the target material in the organic solvent. For example, copper, zinc, nickel, and/or cobalt, in one application, would be considered target materials, and one or more oxyanions, particularly those of arsenic, antimony, bismuth, mercury, iron, and/or aluminum, would be considered to be interferers.

In yet another configuration, the target material is a microbe, particularly a virus, and the non-rare earth-containing treatment element is an anti-microbial agent, other than a rare earth or rare earth-containing composition, and is positioned downstream of the rare earth-containing treatment element. The anti-microbial properties of the rare earth or rare earth-containing composition can be inadequate to provide the desired kill rare of the microbe. In one application, the non-rare earth-containing treatment element is a halogenated resin, and the rare earth or rare earth-containing compound comprises cerium(IV) and/or cerium(III).

### Rare Earth-Containing Treatment Element Downstream of Non-Rare Earth-Containing Treatment Element

In an embodiment, the non-rare earth-containing treatment element 104 removes a phosphorus-containing material upstream of the rare earth-containing treatment element 108. The phosphorous-containing material is an interferer for the removal of a target material by the rare earth-containing treatment element 108. The phosphorous-containing material can be removed by non-rare earth-containing treatment element 108 from the feed stream 100 by contacting the feed stream 100 with one or more of a resin loaded with an amphoteric metal ion, typically in the form of a hydrous oxide; subjecting the feed stream 100 to biological oxidation in an aerobic medium and clarification; introducing into the feed stream 100 a coagulating agent chosen from metal salts of iron and/or of aluminum or salts of alkaline-earth metals; treating the feed stream 100 with from about 0.5 to about 3 ppm of a polymer/iron salt admixture for every 1 ppm of dissolved phosphorus-containing material; contacting the feed stream 100 with a nonmetal silicate, such as a borosilicate; contacting the feed stream 100 with an iron oxide, such as a ferrous or ferric iron-containing compound; contacting the feed stream 100 with an enzymatic composition; contacting the feed stream 100 with a biosorbent pretreated with anionic polymer and an iron salt; contacting the feed stream 100 with fly ash or iron-containing slag, which may be activated by hydrated lime; contacting the feed stream 100 with calcite and/or dolomite; and sorbing the interferer on a yttrium compound held by active carbon.

In another embodiment, the non-rare earth-containing treatment element 104 removes a carbon and oxygen-containing material upstream of the rare earth-containing treatment element 108. The carbon and oxygen-containing material is an interferer for the removal of a target material by the rare earth-containing treatment element 108. The carbon and oxygen-containing material can be removed by non-rare earth-containing treatment element 108 from the feed stream 100 by contacting the feed stream 100 with an alkali, such as lime or soda ash (or other alkalis), sodium hydroxide, or an organic or inorganic acid, such as a mineral acid.

In yet another embodiment, the non-rare earth-containing treatment element 104 removes a halogen-containing material upstream of the rare earth-containing treatment element 108. The carbon and oxygen-containing material it is an interferer for the removal of a target material by the rare earth-containing treatment element 108. The halogen-containing material can be removed from the feed stream 100 by contacting the feed stream 100 with one or more of an aluminum-containing compound, polystyrene based resin with iron oxide, alumina, an alkali or alkaline earth metal, fly ash, and/or a metal hydroxide; contacting the feed stream 100 with alum and/or an alkali or alkaline earth metal aluminate; causing ion exchange between the feed stream 100 and a hydoxide ion-containing material (such as hydroxyapatite or a calcium phosphate/calcium hydroxide composite), whereby dissolved fluoride or halide ions in particular are substituted for the hydroxide ions in the material; contacting the feed stream 100 with a calcium source, such as calcium sulfate, lime, soda ash, calcium hydroxide, limestone, and other calcium sources, and then ferric or aluminum salts; contacting the feed stream 100 with modified or activated alumina particles (the modified alumina particles containing alumina combined with iron or manganese, or both); contacting the feed stream 100 with calcium, carbonate, and phosphate sources, the contacting removes not only the carbonate and phosophate interferers but also sulfate ions; contacting the feed stream 100 with a macroporous, monodispersed, resin, which is doped with iron oxide; contacting with the feed stream 100 with a multivalent metal compound (such compounds being in dissolved ionic and/or solid form and containing multivalent metal elements such as Ca(II), Al(III), Si(IV), Ti(IV), and Zr(IV) in the form of oxides, hydrous oxides and/or basic carbonates); and contacting the feed stream 100 with amorphous iron and aluminum.

In still yet another embodiment, the non-rare earth-containing treatment element 104 removes a silicon-containing material upstream of the rare earth-containing treatment element 108. The carbon and oxygen-containing material is an interferer for the removal of a target material by the rare earth-containing treatment element 108. The silicon-containing material, such as a silicate, can be removed from the feed stream 100 by one or more of contacting the feed stream 100 with one or more of aluminum oxide, a mineral acid, or iron oxide; contacting the feed stream 100 with iron; contacting the feed stream 100 with an aluminum oxide; and contacting the feed stream 100 with a halogen-containing acid, such as HF, HCl, HBr, HI, or HAt, or mixtures thereof.

In yet even another embodiment, the interferer and target material differ in at least one of material valency, oxidation state, ionic radius, charge density, and/or oxidation number. When the target material and interferer differ in such a property, a membrane filter array may be employed as the non-rare earth-containing treatment element 104 to separate most, if not all, of the interferer from most, if not all, of the target material. Preferably, in such a configuration the non-rare earth-containing treatment element 104 is upstream of the rare earth-containing treatment element 108. It can be appreciated that the interferer can be more concentrated in one of the retentate or permeate and the target material can be concentrated in the other of the retentate and permeate depending on the different property of the interferer and target material and whether the non-rare earth-containing treatment element 104 is upstream or downstream of the rare earth-containing treatment element 108. The membrane filter can be one or more of a leaky reverse osmosis (RO) filter, microfilter, or nanofilter. Preferably, the interferer and target material are dissociated multivalent ions that can be separated. The membrane filter array concentrates, most, if not all, of the interferer in a retentate and passes most, if not all, of the target material in a permeate or vice versa. Reverse osmosis and nanofiltration membranes that utilize high removal membranes can have a carbon pre-filter to protect the membrane from damage, such as chlorine damage.

In one configuration, the interferer has a larger atomic (for a single atomic ion) or molecular (for a polyatomic ion, such as an oxyanion) size than the target material. In such a configuration, the non-rare earth-containing treatment element 104 is a membrane filter array positioned upstream of the rare earth-containing treatment element 108. The membrane filter array separates most, if not all, of the interferer in a retentate but passes at least most of the target material in a permeate or vice versa. The membrane filter can be one or more of a leaky reverse osmosis (RO) filter, microfilter, nanofilter, or ultrafilter.

In yet another configuration, the non-rare earth-containing treatment element 104 comprises a chlorine dioxide process upstream of the rare earth-containing treatment element 108. The chlorine dioxide treatment element neither substantially removes escherichia coli nor rotaviruses. The rare earth-containing treatment element 108 substantially removes one or both of the escherichia coli and rotaviruses remaining in the feed stream 100 after the contacting the chlorine dioxide treatment element with the feed stream 100. Preferably, the rare earth-containing treatment element 108 comprises an insoluble rare earth-containing composition. More preferably the insoluble rare earth-containing composition comprises cerium(IV) oxide, even more preferably cerium dioxide (CeO₂).

In some embodiments, the non-rare earth-containing treatment element 104 removes a chemical agent upstream of the rare earth-containing treatment element 108. The chemical agent can substantially interfere with the removal of a target material or may not be substantially removed by the rare earth-containing treatment element. The chemical agent can be removed from the feed stream 100 by contacting the feed stream 100 with one or more of any of the membrane systems described above, by an oxidative process as described above, by biological digestion (such as, by bacteria, algae, microbes, and such); by precipitation and/or sorption (such as, precipitation by a multivalent ion as described above, adsorption on to an active material such as activated carbon, by electrolysis, by exposure to a radiative treatment element, and by reductive process as each of which are described above.

In some embodiments, the non-rare earth-containing treatment element 104 removes an organic material upstream of the rare earth-containing treatment element 108. The organic material can substantially interfere with the removal of a target material or may not be substantially removed by the rare earth-containing treatment element 108. The organic material can be removed from the feed stream 100 by contacting the feed stream 100 with one or more of any of the membrane systems described above, by an oxidative process as described above, by biological digestion (such as, by bacteria, algae, microbes, and such); by precipitation and/or sorption (such as, precipitation by a multivalent ion as described above, adsorption on to an active material such as activated carbon, by electrolysis, by exposure to a radiative treatment element, and by reductive process as each of which are described above.

In some embodiments, the non-rare earth-containing treatment element 104 removes a colorant upstream of the rare earth-containing treatment element 108. The colorant can substantially interfere with the removal of a target material or may not be substantially removed by the rare earth-containing treatment element 108. The colorant can be removed from the feed stream 100 by contacting the feed stream 100 with one or more of any of the membrane systems described above, by an oxidative process as described above, by biological digestion (such as, by bacteria, algae, microbes, and such); by precipitation and/or sorption (such as, precipitation by a multivalent ion as described above, adsorption on to an active material such as activated carbon, by electrolysis, by exposure to a radiative treatment element, and by reductive process as each of which are described above.

In some embodiments, the non-rare earth-containing treatment element 104 removes a lignin and/or flavanoid upstream of the rare earth-containing treatment element 108. The lignin and/or flavanoid can substantially interfere with the removal of a target material or may not be substantially removed by the rare earth-containing treatment element 108. The lignin and/or flavanoid can be removed from the feed stream by contacting the feed stream 100 with one or more of any of the membrane systems described above, by an oxidative process as described above, by biological digestion (such as, by bacteria, algae, microbes, and such); by precipitation and/or sorption (such as, precipitation by a multivalent ion as described above, adsorption on to an active material such as activated carbon, by electrolysis, by exposure to a radiative treatment element, and by reductive process as each of which are described above.

In some embodiments, the non-rare earth-containing treatment element 104 removes an active and/or inactive biological material upstream of the rare earth-containing treatment element 108. The active and/or inactive biological material can substantially interfere with the removal of a target material or may not be substantially removed by the rare earth-containing treatment element 108. The active and/or inactive biological material can be removed from the feed stream 100 by contacting the feed stream 100 with one or more of any of the membrane systems described above, by an oxidative process as described above, by biological digestion (such as, by bacteria, algae, microbes, and such); by precipitation and/or sorption (such as, precipitation by a multivalent ion as described above, adsorption on to an active material such as activated carbon, by electrolysis, by exposure to a radiative treatment element, and by reductive process as each of which are described above.

In another configuration, the rare earth-containing treatment element 108 protects the non-rare earth-treatment element 104 from system upsets, such as but not limited to changes in one or both of temperature and pH. While not wanting to be limited by example, the pH and/or temperature of the feed stream 100 can affect one or both of the removal capacity and efficiency of the non-rare earth-containing treatment element 104. For example, the oxidizing capacity and/or efficiency of one or more of ozone; peroxide; halogen; halogenate; perhalognate; halogenite; hypohalogenite; nitrous oxide, oxyanion; metal-containing oxide; peracid; superoxide; thiourea dioxide; diethylhydroxylamine; haloamine; halogen dioxide; polyoxide; and a combination and/or mixture thereof can be pH dependent. More specifically, the oxidizing capacity and/or efficiency of one or more of halogen; halogenate; perhalognate; halogenite; hypohalogenite; oxyanion; peracid; superoxide; diethylhydroxylamine; haloamine; halogen dioxide; polyoxide; and a combination and/or mixture thereof can be pH dependent. Furthermore, the concentration of, and therefore, the ability to remove a target material from solution one or more of halogen; halogenate; perhalognate; halogenite; hypohalogenite; haloamine; halogen dioxide; polyoxide; and a combination and/or mixture thereof is pH dependent. The removal capacity and/or efficiently of the rare earth-containing treatment element is substantially more effective over greater temperature and pH ranges than non-rare earth-containing treatment elements.

For example, the disinfection efficiency of hypochlorite is substantially affected by pH. Disinfection typically takes place when the pH is from about pH 5.5 to about pH 7.5. Chloramine formation and disinfection efficiency is also affected by pH. For example, monochloramine (NH₂Cl) has a good biocidal efficiency at a pH of no more than about pH7, while dichloroamine (NHCl₂) has a tolerable biocidal efficiency at a pH from about pH 4 to about pH 7 and trichloramine (NCl₃) has an average biocidal efficiency at a pH from about 1 to about pH 3. Regarding disinfecting systems based on hypobromous acid and/or hybromite, a pH value of from about pH 6.5 to about pH 9 are preferred. Oxidative treatment systems based on peroxones require pyxroxy radials (that is, OH⁻), and therefore less efficient at acidic (pH of less than about 7) and neutral (pH of from about pH 5 to about pH 9) pH values than basic pH values (pH values of no less than about pH 9). Peracid activity is affected by temperature and pH. While not wanting to be limited by example, peracetic activity, more effective at a pH value of 7 than at pH values more than pH 8 or no more than pH 6. Furthermore, at a temperature of about 15 degrees Celsius (and at about pH 7) peracetic acid is one-fifth as efficient at deactivating pathogens than at a 35 degrees Celsius (and at about pH 7).

Having the rare earth-containing treatment element 108 downstream of the non-rare earth-containing treatment element 104 can protect from having target material passing through and/or a target material not be removed by the non-rare earth-containing material 104 during a system upset (such as a fluctuation in one or both of temperature and pH value). It can be appreciated that having a rare earth-containing treatment element 108 downstream of the non-rare earth-containing element 104 can protect from having target material passing through and/or a target material not be removed by the non-rare earth-containing material when the target material concentration exceeds the capacity of the non-rare earth-containing treatment element 104 to remove the target material. The rare earth-containing treatment element 104 removes one or more of an oxyanion; an industrial chemical or material; a chemical agent; a dye; a colorant; a dye intermediate; a halogen; an inorganic material; a silicon-containing material; virus; humic acid, tannic acid; a phosphorus-containing material; an organic material; a microbe; a pigment; a colorant; a lignin and/or flavanoid; a biological contaminant; a biological material; or a combination thereof, when the filtration system experiences at least one of a temperature, pH and target material upset. The at least one extrusion substantially impairs the upstream non-rare earth-containing material from at most of the target material from the feed stream.

In one configuration, an interferer for the non-rare earth-containing treatment element 104 is removed by the rare earth-containing treatment element 108, thereby enabling the non-rare earth-containing treatment element 104 to remove a target material different from the interferer. The non-rare earth-containing treatment element 104 can have a much higher capacity and/or preference for the interferer (such as the interferers discussed above) than for the target material when in the presence of a mixed solution of the interferer and target material. By way of example, halogens, oxyanions, organic material, and pigments can interfere with the operation of membrane filters.

FIG. 1 depicts a process. The feed stream 100 contains one or more target materials and one of an interferer and/or other target material.

The feed stream 100 is contacted with the non-rare earth-containing treatment element 104. The non-rare earth-containing treatment element 104 removes at least most, if not substantially all, of one or both of the interferer and/or other target material to form a feed stream 100 substantially devoid of one or both of the interferer and/or other target material.

The feed stream, substantially devoid of one or both of the interferer and/or other target material, is contacted with the rare earth-containing treatment element 108 to remove substantially most, if not all, of the one or more target materials and form a treated feed stream 112. The treated feed stream 112 is substantially devoid of the one or more target materials. Further regarding the other target material, the other target material may or may not be removed by the rare earth-containing treatment element 108. Moreover, the interferer is a material that substantially impairs and/or inhibits the removal of the one or more target materials by the rare earth-containing treatment element 108.

FIG. 2 depicts a process.

The feed stream 100 is contacted with the non-rare earth-containing treatment element 108. The rare earth-containing treatment element 108 removes at least most, if not substantially all, of one or both of the interferer and/or other target material to form a feed stream 100 substantially devoid of one or both of the interferer and/or other target material.

The feed stream, substantially devoid of one or both of the interferer and/or other target material, is contacted with the non-rare earth-containing treatment element 104 to remove substantially most, if not all, of the one or more target materials and form a treated feed stream 204. The treated feed stream 204 is substantially devoid of the one or more target materials. Further regarding the other target material, the other target material may or may not be removed by the non-rare earth-containing treatment element 104. Moreover, the interferer is a material that substantially impairs and/or inhibits the removal of the one or more target materials by the non-rare earth-containing treatment element 104.

### Experimental

Experimental examples are provided below. The examples are provided to illustrate certain embodiments of the invention and are not to be construed as limitations on the invention, as set forth in the appended claims. All parts and percentages are by weight unless otherwise specified.

### Experiment 1

Fifteen ml of CeO₂ was placed in a ⅞″ inner diameter column.

Six-hundred ml of influent containing de-chlorinated water and 3.5×10⁴/ml of MS-2 was flowed through the bed of CeO₂ at flow rates of 6 ml/min, 10 ml/min and 20 ml/min. Serial dilutions and plating were performed within 5 minutes of sampling using the double agar layer method with E. Coli, host and allowed to incubate for 24 hrs at 37° C.

The results of these samples are presented in Table 1.

| Bed and Flow | Influent | Effluent | Percent | |
|---|---|---|---|---|
| Rate | Pop./ml | Pop/ml | reduction | Challenger |
| CeO₂ 6 ml/min | 3.5 × 10⁴ | 1 × 10⁰ | 99.99 | MS-2 |
| CeO₂ 10 ml/min | 3.5 × 10⁴ | 1 × 10⁰ | 99.99 | MS-2 |
| CeO₂ 20 ml/min | 3.5 × 10⁴ | 1 × 10⁰ | 99.99 | MS-2 |

### Experiment 2

The CeO₂ bed treated with the MS-2 containing solution was upflushed. A solution of about 600 ml of de-chlorinated water and 2.0×10⁶/ml of Klebsiella terrgena was prepared and directed through the column at flow rates of 10 ml/min, 40 ml/min and 80 ml/min. The Klebsiella was quantified using the Idexx Quantitray and allowing incubation for more than 24 hrs. at 37° C.

The results of these samples are presented in Table 2.

| Bed and Flow | Influent | Effluent | Percent | |
|---|---|---|---|---|
| Rate | Pop./ml | Pop/ml | reduction | Challenger |
| CeO₂ 10 ml/min | 2.0 × 10⁶ | 1 × 10⁻² | 99.99 | Klebsiella |
| CeO₂ 40 ml/min | 2.0 × 10⁶ | 1 × 10⁻² | 99.99 | Klebsiella |
| CeO₂ 80 ml/min | 2.0 × 10⁶ | 1 × 10⁻² | 99.99 | Klebsiella |

### Experiment 3

The CeO₂ bed previously challenged with MS-2 and Klebsiella terrgena was then challenged with a second challenge of MS-2 at increased flow rates. A solution of about 1000 ml de-chlorinated water and 2.2×10⁵/ml of MS-2 was prepared and directed through the bed at flow rates of 80 ml/min, 120 ml/min and 200 ml/min. Serial dilutions and plating were performed within 5 minutes of sampling using the double agar layer method with E. Coli host and allowed to incubate for 24 hrs at 37° C.

The results of these samples are presented in Table 3.

| Bed and Flow | Influent | Effluent | Percent | |
|---|---|---|---|---|
| Rate | Pop./ml | Pop/ml | reduction | Challenger |
| CeO₂ 80 ml/min | 2.2 × 10⁵ | 1 × 10⁰ | 99.99 | MS-2 |
| CeO₂ 120 ml/min | 2.2 × 10⁵ | 1.4 × 10² | 99.93 | MS-2 |
| CeO₂ 200 ml/min | 2.2 × 10⁵ | 5.6 × 10⁴ | 74.54 | MS-2 |

### Experiment 4

ABS plastic filter housings (1.25 inches in diameter and 2.0 inches in length) were packed with ceric oxide (CeO₂) that was prepared from the thermal decomposition of 99% cerium carbonate. The housings were sealed and attached to pumps for pumping an aqueous solution through the housings. The aqueous solutions were pumped through the material at flow rates of 50 and 75 ml/min A gas chromatograph was used to measure the final content of the chemical agent contaminant. The chemical agent contaminants tested, their initial concentration in the aqueous solutions, and the percentage removed from solution are presented in Table 4.

| | | Starting | % | % |
|---|---|---|---|---|
| | | concen- | Removal | Removal |
| Common | | tration | at 50 | at 75 |
| Name | Chemical Name | (mg/L) | ml/min | ml/min |
| VX | O-ethyl-S-(2- | 3.0 | 99% | 97% |
| | isopropylamino- | | | |
| | ethyl)methylphos- | | | |
| | phonothiolate | | | |
| GB | Isopropyl methyl- | 3.0 | 99.9% | 99.7% |
| (sarin) | phosphono- | | | |
| | fluoridate | | | |
| HD | bis(2-chloro- | 3.0 | 92% | 94% |
| (mustard) | ethyl)sulfide | | | |
| Meth- | O,S-dimethyl phos- | 0.184 | 95% | 84% |
| amidophos | phoramidothioate | | | |
| Mono- | dimethyl (1E)-1- | 0.231 | 100% | 100% |
| chrotophos | methyl-3-(methyl- | | | |
| | amino)-3-oxo-1- | | | |
| | propenyl phosphate | | | |
| Phos- | 2-chloro-3- | 0.205 | 100% | 95% |
| phamidon | (diethylamino)- | | | |
| | 1-methyl-3-oxo- | | | |
| | 1-propenyl dimethyl | | | |
| | phosphate | | | |

### Experiment 5

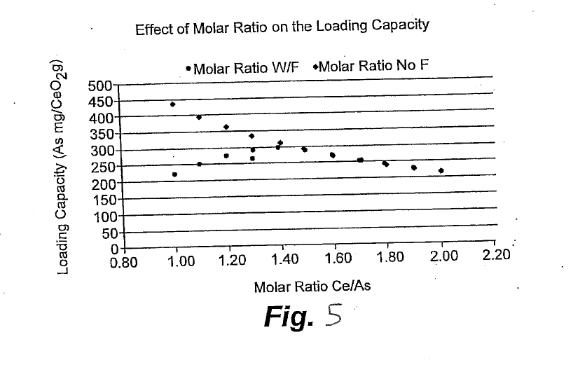

Four filters each containing 25 grams of ceria (cerium dioxide)-coated alumina were challenged with 30 liters of NSF P231 “general test water 2” at a pH of about 9, containing 20 mg/L tannic acid. The ceria-coated alumina pre-filters decreased the oxidant demand of the water from about 41 ppm (NaOCl) to an average of 12 ppm (NaOCl). The oxidant demand of the water treated with the ceria-coated pre-filters decreased by about 75%. This decreased demand translates to a decrease in the amount of halogenated resin necessary to produce a 4 Log₁₀ virus removal. FIG. 5 is a graphical representation of the retention of humic acid on 20 g of ceria-coated alumina challenged by 6 mg/L and a 10 min contact time.

### Experiment 6

Ceria absorbent media was shown to be effective for removing large amounts of natural organic matter, such as humic and/or tannic acids. The organic material was removed at fast water flow rates and small contact times of less than about 30 seconds over a large range of pH values. The organic matter was removed from an aqueous solution with ceria oxide powders having surface areas of about 50 m²/g or greater, about 100 m²/g or greater, and about 130 m²/g or greater. Furthermore, the organic matter was removed from an aqueous stream with cerium oxide-coated alumina having a surface area of about 200 m²/g or greater. Moreover, cerium oxide coated onto other support media or agglomerated cerium oxide powder having a surface area of about 75 m²/g or greater removed humic and/or tannic acids from the aqueous stream. In each instance, the cerium containing material effectively removed the organic matter from the aqueous stream to produce a clear colorless solution. However, the organic matter substantially remained in the organic matter-containing water when the organic matter-containing water was treated with either a hollow fiber microfilter followed by activated carbon packed bed media or with a hollow fiber microfilter. In both of these instances, the treated water was one or both of hazy and colored, indicating the presence of organic matter within the water. The hollow fiber microfilter had a pore size of about 0.2 μm. This further depicts how the organic matter can, in the absence of upstream removal by ceria, foul the downstream hollow fiber microfilter or activated carbon packed bed media.

### Experiment 7

Four hundred ml of 140 mg/L solution of humic acid (over five times the NSF P248 requirement) was passed through a column containing a volume of about 12.3 cm³ of cerium oxide. The column effluent possessed no visible color and a spectrophotometer analysis of the effluent indicated a humic acid removal capacity of about 93%. A batch analysis experiment indicated a humic acid removal capacity of about 175 mg humic acid per cubic inch of cerium oxide bed depth.

### Experiment 8

In a further example, twenty 3.6 g packets of cherry Kool-Aid™ unsweetened soft drink mix (containing Red 40 (as azo dye having the composition 2-naphthalenesulfonic acid, 6-hydroxy-5-((2-methoxy-5-methyl-4-sulfophenyl)azo) disodium salt, and disodium 6-hydroxy-5-((2-methoxy-5-methyl-4-sulfophenyl)azo)-2-naphthalenesulfonate) and Blue 1 (a disodium salt having the formula C₃₇H₃₄N₂Na₂O₉S₃) dyes) were added to and mixed with five gallons of water. For use in the first test, a column setup was configured such that the dyed water stream enters and passes through a fixed bed of insoluble cerium(IV) oxide to form a treated solution. The dyed, colored water was pumped through the column setup. The treated solution was clear of any dyes, and at the top of the bed there was a concentrated band of color, which appeared to be the Red 40 and Blue 1 dyes.

### Experiment 9

In a further example, cherry Kool-Aid™ unsweetened soft drink mix (containing Red 40 and Blue 1 dyes) was dissolved in water, and the mixture stirred in a beaker. Insoluble cerium(IV) oxide was added and kept suspended in the solution by stirring. When stirring ceased, the cerium oxide settled, leaving behind clear, or colorless, water. This example is intended to replicate water treatment by a continuous stirred tank reactor (CSTR).

### Experiment 10

In an eleventh example, 10.6 mg of Direct Blue 15 (C₃₄H₂₄N₆Na₄O₁₆S₄, from Sigma-Aldrich) was dissolved in 100.5 g of de-ionized water. The Direct Blue 15 solution (which was deep blue in color) was stirred for 5 min. using a magnetic stir bar before adding 5.0012 g of high surface area ceria (CeO₂). The ceria-containing Direct Blue 15 solution was stirred. The ceria-containing Direct Blue 15 solution 2 min and 10 min after adding the ceria are, respectively, had a bluish tint but was a much lighter blue than the untreated Direct Blue 15 solution. After stirring for 10 min, a filtrate was extracted using a 0.2 μm syringe filter. The filtrate was clear and substantially colorless, having a slightly visible blue tint.

### Experiment 11

In a twelfth example, 9.8 mg of Acid Blue 25 (45% dye content, C₂₀H₁₃N₂NaO₅S, from Sigma-Aldrich) was dissolved in 100.3 g of de-ionized water. The Acid Blue 25 solution (which was deep blue in color) was stirred for 5 min. using a magnetic stir bar before adding 5.0015 g of high surface area ceria (CeO₂). The ceria-containing Acid Blue 25 solution was stirred. The ceria-containing Acid Blue 25 solution 2 min and 10 min after adding the ceria had, respectively, a bluish tint but was a much lighter blue than the untreated Direct Blue 15 solution. After stirring for 10 min, a filtrate was extracted using a 0.2 μm syringe filter. The filtrate was clear and substantially colorless, and lacked any visible tint.

### Experiment 12

In a thirteenth example, 9.9 mg of Acid Blue 80 (45% dye content, C₃₂H₂₈N₂Na₂O₈S₂, from Sigma-Aldrich) was dissolved in 100.05 g of de-ionized water. The Acid Blue 80 solution (was deep blue in color) was stirred for 5 min. using a magnetic stir bar before adding 5.0012 g of high surface area ceria (CeO₂). The ceria-containing Acid Blue 80 solution was stirred. The ceria-containing Acid Blue 80 solution 2 min and 10 min after adding the ceria are, respectively, had a bluish tint but was a much lighter blue than the untreated Direct Blue 15 solution. After stirring for 10 min, a filtrate was extracted using a 0.2 μm syringe filter. The filtrate was clear and substantially colorless, and lacked any visible tint.

### Experiment 13

A number of tests were undertaken to evaluate solution phase or soluble cerium ion precipitations.

### Test 1:

Solutions containing 250 ppm of Se(IV) or Se(VI) were amended with either Ce(III) chloride or Ce(IV) nitrate at concentrations sufficient to produce a 2:1 mole ratio of Se:Ce. Solids formation was observed within seconds in the reactions between Ce and Se(IV) and also when Ce(IV) was reacted with Se(IV). However, no solids were observed when Ce(III) reacted with Se(VI).

Aliquots of these samples were filtered with 0.45 micron syringe filters and analyzed using ICP-AES. The remaining samples were adjusted to pH 3 when Ce(IV) was added, and to pH 5 when Ce(III) was added. The filtered solutions indicated that Ce(III) did not significantly decrease the concentration of Se(VI). However, Ce(IV) decreased the concentration of soluble Se(VI) from 250 ppm to 60 ppm. Although Ce(IV) did not initially decrease the concentration of Se(IV) at the initial system pH of 1.5, after increasing to pH 3 >99% of the Se was precipitated with residual Ce(IV) after initial filtration may be more appropriate. Ce(III) decreased the concentration of Se(IV) from 250 ppm to 75 ppm upon addition and adjustment to pH 5.

### Test 2:

Solutions containing 250 ppm of Cr(VI) were amended with a molar equivalent of cerium supplied as either Ce(III) chloride or Ce(IV) nitrate. The addition of Ce(III) to chromate had no immediate visible effect on the solution, however 24 hours later there appeared to be a fine precipitate of dark solids. In contrast, the addition of Ce(IV) led to the immediate formation of a large amount of solids.

As with the previous example, aliquots were filtered, and the pH adjusted to pH 3 for Ce(IV) and pH 5 for Ce(III). The addition of Ce(III) had a negligible impact on Cr solubility, however Ce(IV) removed nearly 90% of the Cr from solution at pH 3.

### Test 3:

Solutions containing 250 ppm of fluoride were amended with cerium in 1:3 molar ratio of cerium: fluoride. Again the cerium was supplied as either Ce(III) chloride or Ce(IV) nitrate. While Ce(IV) immediately formed a solid precipitate with the fluoride, Ce(III) did not produce any visible fluoride solids in the pH range 3-4.5.

### Test 4:

Solutions containing 50 ppm of molybdenum Spex ICP standard, presumably molybdate, were amended with a molar equivalent of Ce(III) chloride. As with previous samples, a solid was observed after the cerium addition and an aliquot was filtered through a 0.45 micron syringe filter for ICP analysis. At pH 3, nearly 30 ppm Mo remained in solution, but as pH was increased to 5, the Mo concentration dropped to 20 ppm, and near pH 7 the Mo concentration was shown to be only 10 ppm.

### Test 5:

Solutions containing 50 ppm of phosphate were amended with a molar equivalent of Ce(III) chloride. The addition caused the immediate precipitation of a solid. The phosphate concentration, as measured by ion chromatography, dropped to 20-25 ppm in the pH range 3-6.

### Experiment 14

A series of tests were performed to determine if certain halogens, particularly fluoride (and other halogens), interfere with arsenic and other target material removal when using water soluble cerium chloride (CeCl₃). This will be determined by doing a comparison study between a stock solution containing fluoride and one without fluoride. For materials used were: CeCl₃ (1.194 M Ce or 205.43 g/L REO) and 400 mL of the stock. The constituents of the stock solution, in accordance with NSF P231 “general test water 2” (“NSF”), are shown in Tables 5-6:

TABLE 5
Amount of Reagents Added

| | | Amount of |
|---|---|---|
| | Amount of | Reagent Added |
| | Reagent Added | to 3.5 L (g) |
| Compound | to 3.5 L (g) | No Fluoride |
| NaF | 5.13 | 0 |
| AlCl₃•6H₂O | 0.13 | 0.13 |
| CaCl₂•2 H₂O | 0.46 | 0.46 |
| CuSO₄•5H₂O | 0.06 | 0.06 |
| FeSO₄•7H₂O | 2.17 | 2.16 |
| KCl | 0.16 | 0.15 |
| MgCl₂•6H₂O | 0.73 | 0.74 |
| Na₂SiO₃•9H₂O | 1.76 | 1.76 |
| ZnSO₄•7H₂O | 0.17 | 0.17 |
| Na₂HAsO₄•7H₂O | 18.53 | 18.53 |

TABLE 6
Calculated Analyte Concentrations

| | Theoretical | Theoretical |
|---|---|---|
| | Concentration | Concentration (mg/L) |
| Element | (mg/L) | No Fluoride |
| Cl | 19032 | 15090 |
| Na | 1664 | 862 |
| K | 24 | 22 |
| Cu | 4 | 4 |
| Fe | 125 | 124 |
| Zn | 11 | 11 |
| As | 1271 | 1271 |
| Mg | 25 | 20 |
| Ca | 36 | 36 |
| Al | 16 | 16 |
| Si | 50 | 50 |
| S | 79 | 79 |
| F | 663 | 0 |

The initial pH of the stock solution was pH ˜0-1. The temperature of the stock solution was elevated to 70° C. The reaction or residence time was approximately 90 minutes.

The procedure for precipitating cerium arsenate with and without the presence of fluorine is as follows:

### Step 1:

Two 3.5 L synthetic stock solutions were prepared, one without fluorine and one with fluorine. Both solutions contained the above listed constituents.

### Step 2:

400 mL of synthetic stock solution was measured gravimetrically (402.41 g) and transferred into a 600 mL Pyrex beaker. The beaker was then placed on hot/stir plate and was heated to 70° C. while being stirred.

### Step 3:

Enough cerium chloride was added to the stock solution to meet a predetermined molar ratio of cerium to arsenic. For example, to achieve a molar ratio of one ceria mole to one mole of arsenic 5.68 mL of cerium chloride was measure gravimetrically (7.17 g) and added to the stirring solution. Upon addition of cerium chloride a yellow/white precipitate formed instantaneously, and the pH dropped due to the normality of the cerium chloride solution being 0.22. The pH was adjusted to approximately 7 using 20% sodium hydroxide.

### Step 4:

Once the cerium chloride was added to the 70° C. solution, it was allowed to react for 90 minutes before being sampled.

### Step 5:

Repeat steps 2-4 for all desired molar ratios for solution containing fluoride and without fluoride.

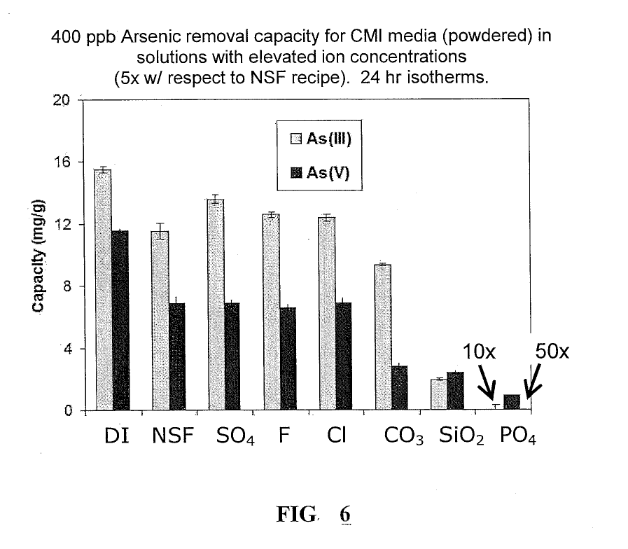

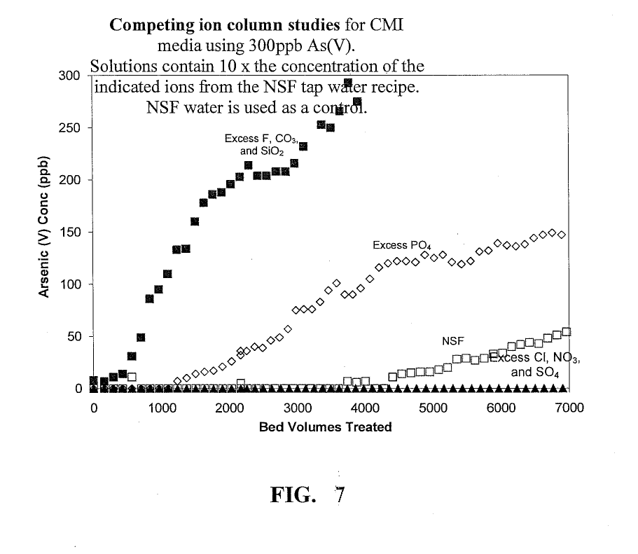

The results are presented in Table 7 and FIGS. 6-7.

Table 7. The residual arsenic concentration in supernatant solution after precipitation with cerium chloride solution.

| | Residual As Concentration | Residual As Concentration no |
|---|---|---|
| Molar Ratio | w/Fluoride Present (mg/L) | Fluoride Present (mg/L) |
| 1.00 | 578 | 0 |
| 1.10 | 425 | 0 |
| 1.20 | 286 | 0 |
| 1.30 | 158.2 | 0 |
| 1.40 | 58.1 | 0 |
| 1.50 | 13.68 | 0 |
| 1.60 | 3.162 | 0 |
| 1.71 | 0 | 0 |
| 1.81 | 10.2 | 0 |
| 1.90 | 0 | 0 |
| 2.01 | 0 | 0 |

A comparison of loading capacities for solutions containing or lacking fluoride suggest a benefit in eliminating the fluoride before the addition of cerium. FIG. 6 shows the effect of fluoride on residual arsenic in the presence of cerium(III). FIG. 7 shows that the loading capacities (which is defined as mg of As per gram of CeO₂) for solutions lacking fluoride are considerably higher at low molar ratios of cerium to arsenic. Steps should be taken to determine a method for the sequestration of fluoride from future stock solutions.

Solutions with a cerium to arsenic molar ratio of approximately 1.4 to 1 or greater had a negligible difference in the loading capacities between solution that contained F⁻ and not having F⁻. This leads one to believe that an extra 40% cerium was needed to sequester the F⁻; then the remaining cerium could react with the arsenic.

These results confirm that the presence of fluoride is interfering with the sequestration of arsenic. The interference comes from the competing reaction forming CeF₃; this reaction has a much more favorable Ksp. A method for pretreatment of fluoride should be considered and developed in order to achieve more efficient use of the cerium.

Accordingly, a fluoride free solution gives better arsenic removal when using lower cerium to arsenic molar ratios, in effect giving higher loading capacities.

### Experiment 16

40.00 g of cerium was added to 1.00 liter of solution containing either 2.02 grams of As(III) or 1.89 grams of As(V). The suspension was shaken periodically, about 5 times over the course of 24 hours. The suspensions were filtered and the concentration of arsenic in the filtrate was measured. For As(III), the arsenic concentration had dropped to 11 ppm. For As(V), the arsenic concentration was still around 1 g/L, so the pH was adjusted by the addition of 3 mL of conc HCl.

Both suspensions were entirely filtered using a vacuum filter with a 0.45 micron track-etched polycarbonate membrane. The final or residual concentration of arsenic in solution was measured by ICP-AES. The solids were retained quantitatively, and resuspended in 250 mL of DI water for about 15 minutes. The rinse suspensions were filtered as before for arsenic analysis and the filtered solids were transferred to a weigh boat and left on the benchtop for 4 hours.

The filtered solids were weighed and divided into eight portions accounting for the calculated moisture such that each sample was expected to contain 5 g of solids and 3.5 g of moisture (and adsorbed salts). One sample of each arsenic laden solid (As(III) or As(V) was weighed out and transferred to a drying oven for 24 hours, then re-weighed to determine the moisture content.

Arsenic-laden ceria samples were weighed out and transferred to 50 mL centrifuge tubes containing extraction solution (Table 8). The solution (except for H2O2) had a 20-hour contact time, but with only occasional mixing via shaking. Hydrogen peroxide contacted the arsenic-laden solids for two hours and was microwaved to 50 degrees Celsius to accelerate the reaction.

A control sample was prepared wherein the 8.5 g arsenic-laden ceria samples were placed in 45 mL of distilled (DI) water for the same duration as other extraction tests.

The first extraction test used 45 mL of freshly prepared 1 N NaOH. To increase the chances of forcing off arsenic, a 20% NaOH solution was also examined. To investigate competition reactions, 10% oxalic acid, 025 M phosphate, and 1 g/L carbonate were used as extracting solutions. To test a reduction pathway 5 g of arsenic-laden ceria was added to 45 mL of 0.1 M ascorbic acid. Alternatively an oxidation pathway was considered using 2 mL 30% H₂O₂ added with 30 mL of DI water

After enough time elapsed for the selected desorption reactions to occur, the samples were each centrifuged and the supernatant solution was removed and filtered using 0.45 micron syringe filters. The filtered solutions were analyzed for arsenic content. Litmus paper was used to get an approximation of pH in the filtered solutions.

Because the reactions based upon redox changes did not show a great deal of arsenic release, the still arsenic-laden solids were rinsed with 15 mL of 1 N NaOH and 10 mL of DI water for 1 hour, then re-centrifuged, filtered, and analyzed.

The results of these desorption experiments can be seen in Table 8. In short, it appears that the desorption of As(III) occurs to a minimal extent. In contrast, As(V) adsorption exhibits an acute sensitivity to pH, meaning that As(V) can be desorbed by raising the pH above a value of 11 or 12. As(V) adsorption is also susceptible to competition for surface sites from other strongly adsorbing anions present at elevated concentrations.

Using hydrogen peroxide, or another oxidant, to convert As(III) to As(V) appeared to be relatively successful, in that a large amount of arsenic was recovered when the pH was raised using NaOH after the treatment with H₂O₂. However, until the NaOH was added, little arsenic desorbed. This indicates that a basic pH level, or basification, can act as an interferer to As(V) removal by ceria.

While ascorbate did cause a dramatic color change in the loaded media, it was unsuccessful in removing either As(III) or As(V) from the surface of ceria. In contrast, oxalate released a detectable amount of adsorbed As(III) and considerably greater amounts of As(V).

In Experiments with Other Adsorbates:

These experiments examined the adsorption and desorption of a series of non-arsenic anions using methods analogous to those established for the arsenic testing.

### Permanganate:

Two experiments were performed. In the first experiment, 40 g of ceria powder were added to 250 mL of 550 ppm KMnO₄ solution. In the second experiment, 20 g of ceria powder were added to 250 mL of 500 ppm KMnO₄ solution and pH was lowered with 1.5 mL of 4 N HCl. Lowering the slurry pH increased the Mn loading on ceria four fold.

In both experiments the ceria was contacted with permanganate for 18 hours then filtered to retain solids. The filtrate solutions were analyzed for Mn using ICP-AES, and the solids were washed with 250 mL of DI water. The non-pH adjusted solids were washed a second time.

Filtered and washed Mn-contacted solids were weighed and divided into a series of three extraction tests and a control. These tests examined the extent to which manganese could be recovered from the ceria surface when contacted with 1 N NaOH, 10% oxalic acid, or 1 M phosphate, in comparison to the effect of DI water under the same conditions.

The sample of permanganate-loaded ceria powder contacted with water as a control exhibited the release of less than 5% of the Mn. As with arsenate, NaOH effectively promoted desorption of permanganate from the ceria surface. This indicates that the basic pH level, or basification, acts as an interferer to permanganate removal by ceria. In the case of the second experiment, where pH was lowered, the effect of NaOH was greater than in the first case where the permanganate adsorbed under higher pH conditions.

Phosphate was far more effective at inducing permanganate desorption than it was at inducing arsenate desorption. Phosphate was the most effective desorption promoter we examined with permanganate. In other words, the ability of the ceria powder to remove permanaganate in the presence of phosphate appears to be relatively low as the capacity of the ceria powder for phosphate is much higher than for permanganate.

Oxalic acid caused a significant color change in the permanganate solution, indicating that the Mn(VII) was reduced, possibly to Mn(II) or Mn(IV), wherein the formation of MnO or MnO₂ precipitates would prevent the detection of additional Mn that may or may not be removed from the ceria. A reductant appears therefore to be an interferer to ceria removal of Mn(VII). In the sample that received no pH adjustment, no desorbed Mn was detected. However, in the sample prepared from acidifying the slurry slightly a significant amount of Mn was recovered from the ceria surface.

### Chromate

250 mL of solution was prepared using 0.6 g sodium dichromate, and the solution was contacted with 20 g of cerium powder for 18 hours without pH adjustment. The slurry was filtered and the solids were washed with DI water then divided into 50 mL centrifuge tubes to test the ability of three solutions to extract chromium from the ceria surface.

Ceria capacity for chromate was significant and a loading of >20 mg Cr/g ceria was achieved without any adjustments to pH or system optimization (pH of filtrate was approximately 8). Likewise, the extraction of adsorbed chromate was also readily accomplished. Raising the pH of the slurry containing chromate-laden ceria using 1 N NaOH was the most effective method of desorbing chromium that was tested. Considerably less chromate was desorbed using phosphate and even less was desorbed using oxalic acid. This indicates that phosphate and oxalic acid are not as strong interferers to chromate removal when compared to permanganate removal. In the control sample, only 5% of the chromate was recovered when the loaded solid was contacted with distilled water.

### Selenite

A liter of selenite solution was prepared using 1 g of Na2SeO2. The pH was lowered using 2 mL of 4 M HCl. 40 g of ceria was added to create a slurry that was provided 18 hours to contact. The slurry was filtered and the Se-loaded ceria was retained, weighed, and divided into 50 mL centrifuge tubes for extraction.

Ceria was loaded with >6 mg/g of Se. While the solids from this reaction were not washed in the preparation stages, the control extraction using DI water exhibited less than 2% selenium release. The extent of selenium adsorption was diminished by adding 1 N NaOH to the loaded ceria, but the effect was not as dramatic as has been seen for other oxyanions. However, by using hydrogen peroxide to oxidize the Se(IV) to Se(VI) the adsorbed selenium was readily released from the ceria surface and recovered. Oxalic acid had no noticeable impact on the extent of selenium adsorption. The presence of an oxidant appears, therefore, to be an interferer to the removal of Se(IV) by ceria.

### Antimony

The solubility of antimony is rather low and these reactions were limited by the amount of antimony that could be dissolved. In this case, 100 mg of antimony (III) oxide was placed into 1 L of distilled water with 10 mL concentrated HCl, allowed several days to equilibrate, and was filtered through a 0.8 micron polycarbonate membrane to remove undissolved antimony. The liter of antimony solution was contacted with 16 g of ceria powder, which was effective removing antimony from solution, but had too little Sb(III) available to generate a high loading on the surface. In part due to the low surface coverage and strong surface-anion interactions, the extraction tests revealed little Sb recovery. Even the use of hydrogen peroxide, which would be expected to convert Sb(III) to a less readily adsorbed species of Sb(V), did not result in significant amounts of Sb recovery.

### Arsenic

Tables 8-11 show the test parameters and results.

TABLE 8
Loading of cerium oxide surface with arsenate and arsenite
for the demonstration of arsenic desorbing technologies.

| | | C | | E | F | | | | | K | L | M |
|---|---|---|---|---|---|---|---|---|---|---|---|---|
| | B | Mass | | Resid | As- | G | H | I | J | Rinse | Rinse | Final |
| | [As] | CeO2 | D | [As] | loading | Wet | Wet | Dry | % | Vol | [As] | [As] |
| A | (g/L) | (g) | pH | (ppm) | (mg/g) | Mass | mass | (g) | Solids | (mL) | (ppm) | (mg/g) |
| As (III) | 2.02 | 40.0 | 9.5 | 0 | 50.5 | 68 | 7.48 | 4.63 | 61.9 | 250 | 0 | 50.5 |
| As (V) | 1.89 | 40.0 | 5 | 149 | 43.5 | 69 | 8.86 | 5.33 | 60.2 | 250 | 163 | 42.5 |

TABLE 9
Loading of cerium oxide surface with arsenate and arsenite
for the demonstration of arsenic desorbing technologies.

| | | | Residual | As- | Rinse | Final |
|---|---|---|---|---|---|---|
| | [As] | | [As] | loading | [As] | [As] |
| | (g/L) | pH | (ppm) | (mg/g) | (ppm) | (mg/g) |
| As(III) | 2.02 | 9.5 | 0 | 50.5 | 0 | 50.5 |
| As(V) | 1.89 | 5 | 149 | 43.5 | 163 | 42.5 |

TABLE 10
Arsenic extraction from the ceria surface
using redox and competition reactions

| | | % As(III) | % As(V) |
|---|---|---|---|
| Extractant | pH | recovered | recovered |
| Water | 7 | 0.0 | 1.7 |
| 1N NaOH | 13 | 0.2 | 60.5 |
| 20% NaOH | 14 | 2.1 | 51.8 |
| 0.25 PO4 | 8 | 0.4 | 15.0 |
| 10 g/L CO3 | 10 | 2.0 | 7.7 |
| 10% oxalate | 2.5 | 3.0 | 16.5 |
| 30% H2O2 | 6 | 2.0 | 1.5 |
| H2O2/NaOH | 13 | 25.2 | 31.0 |
| 0.1M ascorbate | 4 | 0.0 | 0.0 |

TABLE 11
Loading and extraction of other adsorbed elements
from the ceria surface (extraction is shown for each
method as the ‘percent loaded that is recovered)

| | chro- | anti- | | Per- | Per- |
|---|---|---|---|---|---|
| | mate | mony | selenite | manganate | manganate |
| loading pH | 8 | 2 | 6 | 6 | 11 |
| loading (mg/g) | 20 | 1 | 6 | 4 | 0.7 |
| water (% rec) | 5.1 | <2 | 1.6 | 2.6 | 3.4 |
| 1N NaOH (% rec) | 83 | <2 | 40.8 | 49.9 | 17.8 |
| 10% oxalic (% rec) | 25.8 | 2.3 | 0.2 | 22.8 | <3 |
| 0.5M PO4 (% rec) | 60.7 | | | 78.6 | 45.8 |
| 30% H2O2 (% rec) | | 2.3 | 71.9 | | |

### Experiment 17

Experiments were performed to determine whether cerium(IV) solutions can be used to remove arsenic from storage pond process waters, and accordingly determine the loading capacity of ceria used. In these trials the storage pond solutions will be diluted with DI water, since previous test work has confirmed that this yields a better arsenic removal capability. The soluble cerium(IV) species used are Ceric Sulfate (0.1 M) Ce(SO₄)₂ and Ceric Nitrate (Ce(NO₃)₄). The pond solution used has an arsenic split between 27% As(III) and 73% As(V), with a pH of ph 2. Additional components in the pond solution are presented in Table 12 below:

Additional Sol'n Components:

| | As | B | Ce | Cl | Co | Cu | Fe | Na | Ni | Pb | S | Si |
|---|---|---|---|---|---|---|---|---|---|---|---|---|
| Analyte | (ppm) | (ppm) | (ppm) | (ppm) | (ppm) | (ppm) | (ppm) | (ppm) | (ppm) | (ppm) | (ppm) | (ppm) |
| Tailings | 2500 | 270 | 4 | 1100 | 140 | 2400 | 130 | 4800 | 19500 | 9 | 15000 | 870 |
| Pond | | | | | | | | | | | | |
| Solution | | | | | | | | | | | | |

### Test 1:

50 mL of storage pond solution was diluted to 350 mL using DI water, a seven-fold dilution. The diluted pond solution was heated to a boil and 50 mL of 0.1 M Ce(SO₄)₄ was added and mixed for 15 minutes while still at a boil. A yellow/white precipitate formed. This was filtered using a Buchner funnel and 40 Whatman paper. The precipitate was dried at 110° C. overnight, and was weighed at 0.5 g. The filtrate was sampled and filtered using a 0.2μ filter. A full assay was performed on the filtrate using ICP-AES.

### Test 2:

200 mL storage pond solution was diluted to 300 mL using DDI water. The solution was heated to a boil and 8.95 mL of 2.22 Ce(NO₃)₄ was added. The solution boiled for 15 minutes, and a yellow/white precipitate formed. This was filtered using a Buchner funnel and 40 Whatman paper. The precipitate was dried at 110° C. overnight, and was weighed at 2.46 g. The filtrate was sampled and filtered using a 0.2μ filter. A full assay was performed on the filtrate using ICP-AES.

The results are presented in Tables 13-14 below:

TABLE 13

| | As | B | Ce | Cl | Co | Cu | Fe | Na | Ni | Pb | S | Si |
|---|---|---|---|---|---|---|---|---|---|---|---|---|
| Analyte | (ppm) | (ppm) | (ppm) | (ppm) | (ppm) | (ppm) | (ppm) | (ppm) | (ppm) | (ppm) | (ppm) | (ppm) |
| Storage | 2500 | 270 | 4 | 1100 | 140 | 2400 | 130 | 4800 | 19500 | 9 | 15000 | 870 |
| Pond | | | | | | | | | | | | |
| Solution | | | | | | | | | | | | |
| Test 1 | 364 | 273 | 850 | N/A | 133 | 2240 | 126 | 5250 | 14700 | 7 | N/A | 840 |
| 7 FD | | | | | | | | | | | | |
| Test 4 | 639 | 254 | 2900 | N/A | 99 | 2464 | 94 | 4620 | 18480 | 9 | N/A | 601 |
| 1.54 FD | | | | | | | | | | | | |

*Note:
FD denotes “fold dilution” and the dilution has been factored for the reported concentrations

TABLE 14
Calculated Capacities

| | | | | | Percent Ce |
|---|---|---|---|---|---|
| Test | As Removed | CeO₂ | Capacity (mg | Percent As | still in |
| # | (mg) | Used (g) | As/g CeO₂) | Removed | solution |
| 1 | 107 | 0.86 | 124 | 85 | 42 |
| 2 | 372 | 3.44 | 108 | 74 | 32 |

Tables 13 and 14 demonstrate that the cerium(IV) solutions have a preferential affinity for the arsenic. When examining the data closer, it appears that some of the other metals fluctuate in concentrations i.e., nickel. According to the dilution scheme used and the limitations of the instrument, there could be up to 15% error in the reported concentrations, explaining some of the fluctuations. Moving onto to table 12, it shows that tests 1 and 2 removed 85% and 74% of the arsenic respectively.

### Experiment 18

A test solution containing 1.0 ppmw chromium calculated as Cr was prepared by dissolving reagent grade potassium dichromate in distilled water. This solution contained Cr⁺⁶ in the form of oxyanions and no other metal oxyanions. A mixture of 0.5 gram of lanthanum oxide (La₂O₃) and 0.5 gram of cerium dioxide (CeO₂) was slurried with 100 milliliters of the test solution in a glass container. The resultant slurries were agitated with a Teflon coated magnetic stir bar for 15 minutes. After agitation the water was separated from the solids by filtration through Whatman #41 filter paper and analyzed for chromium using an inductively coupled plasma atomic emission spectrometer. This procedure was repeated twice, but instead of slurrying a mixture of lanthanum oxide and cerium dioxide with the 100 milliliters of test solution, 1.0 gram of each was used. The results of these three tests are set forth below in Table 15.

| | Oxyanion | | | | |
|---|---|---|---|---|---|
| | in Water | | | Oxyanion in | Oxyanion |
| Example | Before Test | | Slurried | Water After | Removed |
| Number | Element | (ppmw) | Material | Test (ppmw) | (percent) |
| 1 | Cr | 1.0 | 0.5 gm La₂O₃ | ≦0.013 | ≧98.7 |
| | | | 0.5 gm CeO₂ | | |
| 2 | Cr | 1.0 | 1.0 gm CeO₂ | ≦0.001 | ≧99.9 |
| 3 | Cr | 1.0 | 1.0 gm La₂O₃ | ≦0.015 | ≧98.5 |
| 4 | Sb | 1.0 | 0.5 gm La₂O₃ | ≦0.016 | ≧98.4 |
| | | | 0.5 gm CeO₂ | | |
| 5 | Sb | 1.0 | 1.0 gm CeO₂ | ≦0.016 | ≧98.4 |
| 6 | Sb | 1.0 | 1.0 gm La₂O₃ | ≦0.100 | ≧90.0 |
| 7 | Mo | 1.0 | 0.5 gm La₂O₃ | ≦0.007 | ≧99.3 |
| | | | 0.5 gm CeO₂ | | |
| 8 | Mo | 1.0 | 1.0 gm CeO₂ | ≦0.001 | ≧99.9 |
| 9 | Mo | 1.0 | 1.0 gm La₂O₃ | ≦0.009 | ≧99.1 |
| 10 | V | 1.0 | 1.0 gm La₂O₃ | ≦0.004 | ≧99.6 |
| 11 | V | 1.0 | 1.0 gm CeO₂ | ≦0.120 | 88.0 |
| 12 | V | 1.0 | 1.0 gm La₂O₃ | ≦0.007 | ≧99.3 |
| 13 | U | 2.0 | 0.5 gm La₂O₃ | ≦0.017 | ≧98.3 |
| | | | 0.5 gm CeO₂ | | |
| 14 | U | 2.0 | 1.0 gm CeO₂ | ≦0.500 | 75.0 |
| 15 | U | 2.0 | 1.0 gm La₂O₃ | ≦0.050 | ≧95.0 |
| 16 | W | 1.0 | 0.5 gm La₂O₃ | ≦0.050 | ≧95.0 |
| | | | 0.5 gm CeO₂ | | |
| 17 | W | 1.0 | 1.0 gm CeO₂ | ≦0.050 | ≧95.0 |
| 18 | W | 1.0 | 1.0 gm La₂O₃ | ≦0.050 | ≧95.0 |

As can be seen the lanthanum oxide, the cerium dioxide and the equal mixture of each were effective in removing over 98 percent of the chromium from the test solution.

### Experiment 19

The procedures of Experiment 17 were repeated except that a test solution containing 1.0 ppmw antimony calculated as Sb was used instead of the chromium test solution. The antimony test solution was prepared by diluting with distilled water a certified standard solution containing 100 ppmw antimony along with 100 ppmw each of As, Be, Ca, Cd, Co, Cr, Fe, Li, Mg, Mn, Mo, Ni, Pb, Se, Sr, Ti, Tl, V, and Zn. The results of these tests are also set forth in Table 15 and show that the two rare earth compounds alone or in admixture were effective in removing 90 percent or more of the antimony from the test solution.

### Experiment 20

The procedures of Experiment 17 were repeated except that a test solution containing 1.0 ppmw molybdenum calculated as Mo was used instead of the chromium test solution. The molybdenum test solution was prepared by diluting with distilled water a certified standard solution containing 100 ppmw molybdenum along with 100 ppmw each of As, Be, Ca, Cd, Co, Cr, Fe, Li, Mg, Mn, Ni, Pb, Sb, Se, Sr, Ti, Tl, V, and Zn. The results of these tests are set forth in Table 15 and show that the lanthanum oxide, the cerium dioxide and the equal weight mixture of each were effective in removing over 99 percent of the molybdenum from the test solution.

### Experiment 21

The procedures of Experiment 17 were repeated except that a test solution containing 1.0 ppmw vanadium calculated as V was used instead of the chromium test solution. The vanadium test solution was prepared by diluting with distilled water a certified standard solution containing 100 ppmw vanadium along with 100 ppmw each of As, Be, Ca, Cd, Co, Cr, Fe, Li, Mg, Mn, Mo, Ni, Pb, Sb, Se, Sr, Ti, Tl, and Zn. The results of these tests are set forth in Table 15 and show that the lanthanum oxide and the equal weight mixture of lanthanum oxide and cerium dioxide were effective in removing over 98 percent of the vanadium from the test solution, while the cerium dioxide removed about 88 percent of the vanadium.

### Experiment 22

The procedures of Experiment 17 were repeated except that a test solution containing 2.0 ppmw uranium calculated as U was used instead of the chromium test solution. The uranium test solution was prepared by diluting a certified standard solution containing 1,000 ppmw uranium with distilled water. This solution contained no other metals. The results of these tests are set forth in Table 15 and show that, like in Examples 10-12, the lanthanum oxide and the equal weight mixture of lanthanum oxide and cerium dioxide were effective in removing the vast majority of the uranium from the test solution. However, like in those examples, the cerium dioxide was not as effective removing about 75 percent of the uranium.

### Experiment 23

The procedures of Experiment 17 were repeated except that a test solution containing 1.0 ppmw tungsten calculated as W was used instead of the chromium test solution. The tungsten test solution was prepared by diluting a certified standard solution containing 1,000 ppmw tungsten with distilled water. The solution contained no other metals. The results of these tests are set forth in Table 15 and show that the lanthanum oxide, cerium dioxide, and the equal weight mixture of lanthanum oxide and cerium dioxide were equally effective in removing 95 percent or more of the tungsten from the test solution.

### Experiment 24

A cerium dioxide powder, having a 400 ppb arsenic removal capacity, was contacted with various solutions containing arsenic(III) as arsenite and arsenic(V) as arsenate and elevated interferer ion concentrations. The interferers included sulfate ion, fluoride ion, chloride ion, carbonate ion, silicate ion, and phosphate ion at concentrations of approximately 500% of the corresponding NSF concentration for the ion. The cerium dioxide powder was further contacted with arsenic-contaminated distilled and NSF P231 “general test water 2” (“NSF”) water. Distilled water provided the baseline measurement.

The results are presented in FIG. 6. As can be seen from FIG. 6, the ions in NSF water caused, relative to distilled water, a decreased cerium dioxide capacity for both arsenite and arsenate. The presence of sulfate, fluoride, and chloride ions had a relatively small adverse effect relative cerium dioxide capacity for arsenite and arsenate compared to distilled water. The presence of carbonate ion decreased the cerium dioxide removal capacity for arsenate more than arsenite. The presence of silicate ion decreased substantially cerium dioxide removal capacities for both arsenite and arsenate. Finally, phosphate ion caused the largest decrease in cerium dioxide removal capacities for arsenite (10× NSF concentration) and arsenate (50× NSF concentration), with the largest decrease in removal capacity being for arsenite.

### Experiment 25

Additional competing ion column studies were performed for a 300 ppb arsenate solution and the cerium powder of the prior experiment. The solution contained ten times the concentrations of fluoride ion, chloride ion, carbonate ion, sulfate ion, silicate ion, nitrate ion, and phosphate ion relative to the NSF standard.

The results are shown in FIG. 7. The greatest degree of arsenate removal was experienced in the solutions containing elevated levels of chloride, nitrate, and sulfate ion. The next greatest degree of arsenate removal was for the NSF solution. The next greatest degree of arsenate removal was for the solution containing elevated levels of phosphate ion. Finally, the lowest degree of arsenate removal was for the solution containing elevated levels of fluorine, carbonate, and silicate ion.

### Experiment 26

An experiment was performed to determine how arsenic speciation affects arsenic removal capacity for a soluble rare earth, particularly cerium chloride.

0.5 L of 300 ppb arsenic (As) V in pH 7.5 NSF 53 water, 0.5 L of 300 ppb As III in pH 7.5 NSF 53 water, and 0.5 L 150 ppb As V/150 ppb As III in pH 7.5±0.25 NSF 53 water were prepared in 0.5 L bottles. A 10 mL sample of each influent was obtained and put into a capped test tube. A 100 ppm cerium (Ce) stock solution was prepared from 520 ppm (CeO₂) cerium chloride. 2.75 mL of the prepared stock solution was added to each 0.49 L of influent to produce a 1:1 molar ratio for As and Ce. Bottles were then sealed with electrical tape. The three bottles and three influent samples were placed in the tumbler for 24 hours. After 24 hours, a 10 mL sample was taken from each bottle and was filtered. Isotherm and influent samples were submitted for analysis by Inductively Coupled Plasma-Mass Spectrometry (ICP-MS).

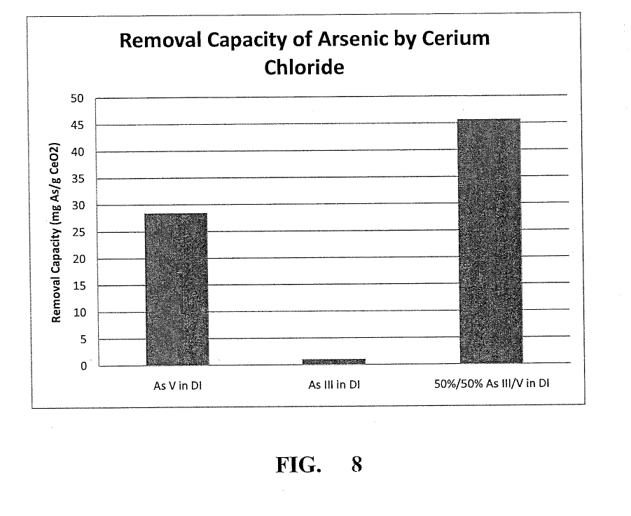

The results are shown in FIG. 8. When cerium chloride was added to the arsenic influent in a 1:1 Ce:As molar ratio, the cerium chloride formed a complex with the arsenic, removing it from solution. Cerium chloride was found to have the greatest efficiency at removing a 50%/50% mixture of As(III) as arsenite and As(V) as arsenate. This removal capacity was found to be 45.7 mg of As per gram of cerium oxide (CeO₂). Cerium chloride was seen remove 28.5 mg of As(V) per gram of CeO₂ and 1.0 mg of As(III) per gram of CeO₂. Unlike the agglomerated media prepared from CeO₂ powder, cerium chloride has a greater affinity for As(V) than As(III). From this data, it can be concluded that cerium chloride should be used in situations when the arsenic present is in the 5⁺ oxidation state.

A number of variations and modifications of the invention can be used. It would be possible to provide for some features of the invention without providing others.

The present invention, in various embodiments, configurations, or aspects, includes components, methods, processes, systems and/or apparatus substantially as depicted and described herein, including various embodiments, configurations, aspects, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method, comprising:
(a) receiving a feed stream comprising a target material and an interferer, the target material and interferer being different;
(b) contacting the feed stream with an upstream treatment element to remove at least most of the interferer while leaving at least most of the target material in an intermediate feed stream; and
(c) thereafter contacting the feed stream with a downstream treatment element to remove at least most of the target material, wherein the interferer interferes with removal of the target material by the downstream treatment element, wherein the upstream treatment element is one of a rare earth-containing treatment element and a non-rare earth-containing treatment element, and wherein the downstream treatment element is the other of a rare earth-containing treatment element and a non-rare earth-containing treatment element.

2. The method of claim 1, wherein the non-rare earth-containing treatment element is substantially free of a rare earth and wherein the interferer has a greater affinity for the downstream treatment element than does the target material.

3. The method of claim 2, wherein the downstream treatment element is the rare earth-containing treatment element, wherein the upstream treatment element is the non-rare earth-containing treatment element, wherein the interferer comprises one or more of the following: PO₄³⁻, CO₃²⁻, SiO₃²⁻, bicarbonate, vanadate, and a halogen, and wherein the target material is one or more of a chemical agent, a colorant, a dye intermediate, a biological material, an organic carbon, a microbe, an oxyanion, and mixtures thereof.

4. The method of claim 3, wherein the target material comprises an oxyanion of at least one of arsenic, aluminum, astatine, bromine, boron, fluorine, iodine, silicon, titanium, vanadium, chromium, manganese, gallium, thallium, germanium, selenium, mercury, zirconium, niobium, molybdenum, ruthenium, rhodium, indium, tin, antimony, tellurium, hafnium, tantalum, tungsten, rhenium, iridium, platinum, lead, uranium, plutonium, americium, curium, and bismuth.

5. The method of claim 3, wherein the target material is a chemical agent, the chemical agent comprising one or more of a pesticide, rodenticide, herbicide, insecticide, and fertilizer.

6. The method of claim 3, wherein the target material is at least one of a colorant and dye intermediate.

7. The method of claim 3, wherein the target material is a biological material.

8. The method of claim 3, wherein the target material is an organic carbon.

9. The method of claim 3, wherein the target material is an active microbe.

10. The method of claim 3, wherein the target material is an oxyanion.

11. The method of claim 3, wherein the downstream treatment element is the non-rare earth-containing treatment element, wherein the upstream treatment element is the rare earth-containing treatment element, and wherein the interferer and target material are each one or more of a chemical agent, a colorant, a dye intermediate, a biological material, an organic carbon, a microbe, an oxyanion, a halogen, a halide compound, and mixtures thereof.

12. The method of claim 11, wherein the non-rare earth-containing treatment element is a membrane and the interferer is one or more of a halogen and a halide compound.

13. The method of claim 11, wherein the non-rare earth-containing treatment element comprises an oxidant and wherein the interferer is an oxidizable material.

14. The method of claim 13, wherein the oxidant, relative to the target material, preferentially oxidizes the interferer.

15. The method of claim 11, wherein the non-rare earth-containing treatment element comprises a reductant and wherein the interferer is a reducible material.

16. The method of claim 15, wherein the reductant, relative to the target material, preferentially reduces the interferer.

17. The method of claim 11, wherein the non-rare earth-containing treatment element comprises a precipitant and wherein the interferer is co-precipitated with the target material by the precipitant.

18. The method of claim 11, wherein the non-rare earth-containing treatment element comprises an ion exchange medium and wherein the interferer is, relative to the target material, a competing ion for sites on the ion exchange medium.

19. The method of claim 11, wherein the non-rare earth-containing treatment element comprises an ion exchange medium and wherein the interferer is at least one of a foulant, the at least one of a foulant detrimentally impacting operation of the non-rare earth-containing treatment element.

20. The method of claim 11, wherein the non-rare earth-containing treatment element comprises an organic solvent in a solvent exchange circuit and wherein the interferer and the target material are, under the selected operating conditions of the solvent exchange circuit, soluble in the organic solvent.

21. The method of claim 1, wherein target material is a chemical agent, the chemical agent being one or more of acetaldehyde, acetone, acrolein, acrylamide, acrylic acid, acrylonitrile, aldrin/dieldrin, ammonia, aniline, arsenic, atrazine, barium, benzidine, 2,3-benzofuran, beryllium, 1,1′-biphenyl, bis(2-chloroethyl)ether, bis(chloromethyl)ether, bromodichloromethane, bromoform, bromomethane, 1,3-butadiene, 1-butanol, 2-butanone, 2-butoxyethanol, butraldehyde, carbon disulfide, carbon tetrachloride, carbonyl sulfide, chlordane, chlorodecone and mirex, chlorfenvinphos, chlorinated dibenzo-p-dioxins (CDDs), chlorine, chlorobenzene, chlorodibenzofurans (CDFs), chloroethane, chloroform, chloromethane, chlorophenols, chlorpyrifos, cobalt, copper, creosote, cresols, cyanide, cyclohexane, DDT, DDE, DDD, DEHP, di(2-ethylhexyl)phthalate, diazinon, dibromochloropropane, 1,2-dibromoethane, 1,4-dichlorobenzene, 3,3′-dichlorobenzidine, 1,1-dichloroethane, 1,2-dichloroethane, 1,1-dichloroethene, 1,2-dichloroethene, 1,2-dichloropropane, 1,3-dichloropropene, dichlorvos, diethyl phthalate, diisopropyl methylphosphonate, di-n-butylphtalate, dimethoate, 1,3-dinitrobenzene, dinitrocresols, dinitrophenols, 2,4- and 2,6-dinitrotoluene, 1,2-diphenylhydrazine, di-n-octylphthalate (DNOP), 1,4-dioxane, dioxins, disulfoton, endosulfan, endrin, ethion, ethylbenzene, ethylene oxide, ethylene glycol, ethylparathion, fenthions, formaldehyde, freon 113, heptachlor and heptachlor epoxide, hexachlorobenzene, hexachlorobutadiene, hexachlorocyclohexane, hexachlorocyclopentadiene, hexachloroethane, hexamethylene diisocyanate, hexane, 2-hexanone, HMX (octogen), hydraulic fluids, hydrazines, hydrogen sulfide, isophorone, malathion, MBOCA, methamidophos, methanol, methoxychlor, 2-methoxyethanol, methyl ethyl ketone, methyl isobutyl ketone, methyl mercaptan, methylparathion, methyl t-butyl ether, methylchloroform, methylene chloride, methylenedianiline, methyl methacrylate, methyl-tert-butyl ether, mirex and chlordecone, monocrotophos, N-nitrosodimethylamine, N-nitrosodiphenyl amine, N-nitrosodi-n-propylamine, naphthalene, nitrobenzene, nitrophenols, perchloroethylene, pentachlorophenol, phenol, phosphamidon, phosphorus, polybrominated biphenyls (PBBs), polychlorinated biphenyls (PCBs), polycyclic aromatic hydrocarbons (PAHs), propylene glycol, phthalic anhydride, pyrethrins and pyrethroids, pyridine, RDX (cyclonite), selenium, styrene, sulfur dioxide, sulfur trioxide, sulfuric acid, 1,1,2,2-tetrachloroethane, tetrachloroethylene, tetryl, thallium, tetrachloride, trichlorobenzene, 1,1,1-trichloroethane, 1,1,2-trichloroethane, trichloroethylene (TCE), 1,2,3-trichloropropane, 1,2,4-trimethylbenzene, 1,3,5-trinitrobenzene, 2,4,6-trinitrotoluene (TNT), vinyl acetate, and vinyl chloride.

22. The method of claim 8, wherein the target material comprises one or more of a carbonyl and carboxyl group.

23. The method of claim 11, wherein the non-rare earth-containing treatment element comprises a copper/silver ionization treatment element and the interferer comprises an oxyanion.

24. The method of claim 1, wherein a preference and/or removal capacity of the downstream treatment element for removing the interferer is more than about 1.5 times the preference and/or removal capacity of the downstream treatment element for removing the interferer.

25. The method of claim 1, wherein a removal capacity and/or preference of the upstream treatment element for the interferer is more than about 1.5 times the removal capacity and/or preference for the target material.

26. The method of claim 11, wherein the non-rare earth-containing treatment element is a peroxide process and wherein the interferer reacts with peroxide to substantially generate molecular oxygen.

27. The method of claim 11, wherein the interferer is one or more of a phosphorus-containing composition, a carbon- and oxygen-containing compound, a halogen, a halogen-containing composition, and a silicon-containing composition.

28. A system, comprising:
(a) in input to receive a feed stream comprising a target material and an interferer, the target material and interferer being different;
(b) an upstream treatment element to remove from the feed stream at least most of the interferer while leaving at least most of the target material in an intermediate feed stream; and
(c) a downstream treatment element to remove from the intermediate feed stream at least most of the target material, wherein the interferer interferes with removal of the target material by the downstream treatment element, wherein the upstream treatment element is one of a rare earth-containing treatment element and a non-rare earth-containing treatment element, and wherein the downstream treatment element is the other of a rare earth-containing treatment element and a non-rare earth-containing treatment element.

29. The method of claim 28, wherein the upstream treatment element is a rare earth-containing treatment element and the downstream treatment element is a non-rare earth-containing treatment element.

30. The method of claim 28, wherein the upstream treatment element is a non-rare earth-containing treatment element and the downstream treatment element is a rare earth-containing treatment element.

31. A method, comprising:
(a) receiving a feed stream comprising a target material, the target material being at a first pH and first temperature;
(b) contacting the feed stream with a non-rare earth-containing treatment element to remove at least a first portion of the target material to form an intermediate feed stream having a lower target material concentration than the feed stream; and
(c) contacting the intermediate feed stream with a rare earth-containing treatment element to remove at least a second portion of the target material to form a treated feed stream.

32. The method of claim 31, wherein, in a first mode, the non-rare earth-containing treatment element removes at least most of the target material when the first pH and/or first temperature is within a first set of values and, in a second mode, the non-rare earth-containing treatment element does not remove at least most of the target material when the first pH and/or first temperature is within a second set of values, the first and second set of values being non-overlapping.

33. The method of claim 32, wherein, in the first mode, the rare earth-containing treatment element does not remove at least most of the target material and, in the second mode, the rare earth-containing treatment element removes at least most of the target material.

34. A method, comprising:
(a) receiving a feed stream comprising a target material;
(b) contacting the feed stream with a rare earth-containing treatment element to remove at least a first portion of the target material to form an intermediate feed stream having a lower target material concentration than the feed stream;
(b) contacting the intermediate feed stream with a non-rare earth-containing treatment element to remove at least a second portion of the target material to form a treated feed stream.

35. The method of claim 34, wherein the target material is a microbe and the non-rare earth-containing treatment element comprises an anti-microbial agent.

36. A method, comprising:
(a) receiving a feed stream comprising first and second target materials, the first and second target materials being at least one of a biological material and a microbe;
(b) treating, by a chlorine dioxide process, the feed stream to remove at least most of the first target material and form an intermediate stream; and
(c) treating, by a rare earth-containing treatment element, the intermediate stream to remove at least most of the second target material, the first and second target materials being different and the second target material being one or both of Escherichia coli and a rotovirus.

37. A method, comprising:
(a) receiving a feed stream comprising at least one of a carbonate and bicarbonate;
(b) contacting the feed stream with a cerium(IV) compound to remove at least a portion of the at least one of the carbonate and bicarbonate and form a treated stream.

38. The method of claim 37, wherein the cerium(IV) compound is cerium(IV) oxide and wherein the at least one of a carbonate and bicarbonate is carbonate.

39. The method of claim 37, wherein the cerium(IV) compound is cerium(IV) oxide and wherein the at least one of a carbonate and bicarbonate is bicarbonate.
